(19) United States
(12) Patent Application Publication
(10) Pub. No.: US 2026/0089561 A1
(43) Pub. Date: Mar. 26, 2026

(54) METHODS AND DEVICES FOR INCREMENTAL DATA TRANSMISSION WITH CHANNEL AND SOURCE CODING

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA)

(21) Appl. No.: 19/384,357

(22) Filed: Nov. 10, 2025

Related U.S. Application Data
(63) Continuation of application No. PCT/CN2023/093296, filed on May 10, 2023.

(51) Int. Cl. H04W 28/06; H04L 5/00; H04W 28/02

(52) U.S. Cl. CPC H04W 28/06; H04L 5/0048; H04W 28/0236

(57) ABSTRACT

In current wireless communications, air interface overhead resulting from data transmission between devices is too large, especially when the traffic involves sensing or artificial intelligence (AI) tasks. To try to reduce the air interface overhead, the present disclosure provides methods and devices for incremental data transmission with channel and source coding. According to an aspect of the present disclosure, the method may include transmitting, in a first transmission, a first subset of source data that is channel encoded. The method may further include receiving feedback indicating that a further transmission related to the source data is required. In response to receiving the feedback, the method may further include transmitting a second transmission that comprises either a retransmission of the first subset of the source data or a second subset of the source data that is different from the first subset of the source data.

### CROSS-REFERENCE TO RELATED APPLICATION

This application is a continuation of International Patent Application No. PCT/CN2023/093296, filed on May 10, 2023, which is herein incorporated by reference in its entirety.

### TECHNICAL FIELD

The present application relates to wireless communication generally, and, in particular, to source coding and channel coding in the physical layer of a digital communication system, such as in the physical layer of a wireless communication system.

### BACKGROUND

In a digital communication system, the bits of information to be transmitted over a channel to a receiving device may undergo source encoding in the physical layer. Source encoding is compression by encoding the bits to use fewer bits than the original representation. Therefore, source encoding is also called data compression or bit-rate reduction. The source encoding referred to herein is primarily source encoding in the physical layer and may exist independent of compression techniques that might or might not be applied at higher layers (e.g., the application layer) of the network.

The source encoded bits (i.e., the compressed bits) may be subsequently decompressed via source decoding. For example, bits of information may be source encoded by a transmitting device, transmitted over a channel, received by a receiving device, and source decoded by the receiving device. The process of source encoding/decoding may be referred to as source coding, and source encoded bits may be referred to as being source coded. A known example implementation of source coding is the Lempel-Ziv-Welch (LZW) algorithm.

The compression performed by the source encoding may be lossless or lossy. Lossless compression is compression in which no information is lost in the compression, assuming no errors are introduced during transmission of the compressed bits over the channel. For example, a lossless compression algorithm may reduce the number of information bits by identifying and eliminating statistical redundancy. Lossy compression is compression in which some of the original information is lost by the compression and cannot be recovered during the decompression. For example, unnecessary or less important information may be dropped during the source encoding. Both lossless and lossy source coding methods are known.

In addition to source encoding, channel encoding may also be implemented to apply forward error correction (FEC) in which redundancy (e.g., parity bits) are added to be used by the receiving device to try to correct errors introduced during transmission. For example, after source encoding, but prior to modulation, a channel encoder may perform channel encoding to apply FEC, e.g., to map L bits to L+P bits, where P are redundant bits in the form of parity bits. Channel encoded bits are transmitted over the channel to the receiving device. During the transmission, errors may be introduced. The receiving device applies channel decoding in which at least some of the parity bits are used to try to correct one or more errors introduced during transmission. The process of channel encoding/decoding may be referred to as channel coding. A known example implementation of channel coding is low-density parity-check (LDPC) coding.

A wireless communication system typically implements digital communication. Electronic devices, such as user equipments (UEs), wirelessly communicate with a network via one or more transmit-and-receive points (TRPs). A transport block (TB) includes bits of data to be transmitted over the wireless channel. Data, as used herein, may include control information or any other type of information or traffic. Hybrid automatic repeat request (HARQ) is a method in which channel coding is implemented to try to correct errors, but if the receiving device is unable to correct all errors a retransmission is performed. The HARQ method provides a framework for managing the retransmission so that, for example, the transmitting device knows when it needs to retransmit, and the receiving device knows whether a received packet is an initial or retransmission, and if it is a retransmission, the receiving device knows the TB to which the retransmission relates. For example, the HARQ method may operate such that a receiving device is to return a negative acknowledgement (NACK) if a retransmission is required, and a HARQ process ID may be used to associate a retransmission with a particular TB.

### SUMMARY

In current wireless communications, such as long-term evolution (LTE) or new radio (NR), air interface overhead resulting from wireless data transmission between devices, for example between a user equipment (UE) and a network device (e.g., a transmit-and-receive point (TRP)), is large. The air interface overhead may result from various factors. For example, the source coding and channel coding might be separately performed where lossless compression is applied to source coding. The separate source and channel coding might result in a long block length, especially when lossless compression is applied. For source recovery, HARQ, which is a combination of forward error correction (FEC) and automatic repeat request (ARQ), might be applied to overcome channel fading so that there might be additional data transmissions. For data transmission, error-free transmission is often a target of data transmission in a communication system, although, at least in some cases, a certain level of distortion or transmission error might be acceptable and might not give significant negative impact on overall performance.

The problem related to large air interface overhead is worse when applications and use scenarios involve information (e.g., traffic) resulting from sensing or artificial intelligence (AI), because sensing or AI may allow or require real-time or physical source coding and transmission with channel coding. Given that more applications and use scenarios are expected to involve transmitting information resulting from sensing or AI in future wireless communications, such as sixth generation (6G) wireless communication, there is a need for reducing air interface overhead.

Aspects of the present disclosure provide solutions to try to overcome the aforementioned problems, for example specific methods and devices for incremental data transmission with channel and source coding.

According to an aspect of the present disclosure, there is provided a method performed by a device, for example but not limited to a base station (BS) or a user equipment (UE), for data transmission. The method may include transmitting, in a first transmission, first data that is channel encoded. The method may further include receiving feedback indicating that a further transmission related to the first data is required. In response to receiving the feedback, the method may further include transmitting a second transmission that comprises either a retransmission of the first data or second data that is different from the first data.

In some embodiments, at least one of the first data or the second data is source coded or compressed.

In some embodiments, the first data may be a first subset of source data and the second data may be a second subset of the source data that is different from the first subset of the source data.

In some embodiments, the feedback may include at least one of: a channel decoding outcome of the first subset of the source data transmitted in the first transmission; a source decoding outcome associated with the first subset of the source data transmitted in the first transmission; information indicative of a degree of distortion present in the first subset of the source data transmitted in the first transmission after channel decoding of the first subset of the source data; or performance information indicative of performance of source recovery or task execution that was based on the first subset of the source data transmitted in the first transmission.

In some embodiments, the second transmission may include either the retransmission of the first subset of the source data or the second subset of the source data, depending on the degree of distortion present in the first subset of the source data transmitted in the first transmission after channel decoding of the first subset of the source data.

In some embodiments, the feedback may include the channel decoding outcome and the performance information. The channel decoding outcome may indicate that channel decoding of the first subset of the source data was successful, and the performance information may indicate that the source recovery or task execution failed. In some embodiments, in response, the second transmission includes the second subset of the source data, rather than a retransmission of the first subset of the source data.

In some embodiments, the feedback may include the channel decoding outcome and the information indicative of the degree of distortion. The channel decoding outcome may indicate that channel decoding of the first subset of the source data failed, and the information indicative of the degree of distortion may be below a distortion ratio threshold or within a distortion ratio range. In some embodiments, in response, the second transmission includes the second subset of the source data, rather than a retransmission of the first subset of the source data.

In some embodiments, the feedback further may include the performance information, and the performance information may indicate that source recovery or task execution failed.

In some embodiments, the feedback may include the channel decoding outcome only when the performance information indicates that the source recovery or the task execution failed.

In some embodiments, the method may further include configuring a performance criterion to be used for evaluating the performance of the source recovery or the task execution; and transmitting the configured performance criterion.

In some embodiments, the information indicative of the degree of distortion may include distortion status information (DSI). The DSI may be determined based on an estimated code block error ratio or an estimated bit error ratio of the first subset of the source data transmitted in the first transmission.

In some embodiments, the method may further include receiving second feedback comprising at least one of: a channel decoding outcome of the first subset or the second subset of the source data transmitted in the second transmission; a source decoding outcome associated with the first subset or the second subset of the source data transmitted in the second transmission; information indicative of how much distortion is present in the first subset or the second subset of the source data transmitted in the second transmission; or second performance information indicative of performance of the source recovery or the task execution that was based on the first subset or the second subset of the source data transmitted in the second transmission.

In some embodiments, the second feedback may include the second performance information, the second performance information may indicate success of the source recovery or the task execution, and the method may further include transmitting information comprising a source process identifier indicative of the source data and an indication triggering flush of a buffer associated with the source process identifier.

In some embodiments, the second feedback may include the second performance information, the second performance information may indicate success of the source recovery or the task execution, and the method may further include receiving information comprising a source process identifier indicative of the source data and an indication triggering flush of a buffer associated with the source process identifier; and flushing the buffer associated with the source process identifier.

In some embodiments, the information indicative of how much distortion is present in the first subset or the second subset of the source data transmitted in the second transmission may include distortion status information (DSI). The DSI may be determined based on an estimated code block error ratio or an estimated bit error ratio of the first subset or the second subset of the source data transmitted in the second transmission.

In some embodiments, the first subset of the source data may be transmitted or retransmitted with at least one of: an identifier for the first subset of the source data; information indicative of a location of the first subset of the source data within the source data; information identifying a source process identifier indicative of the source data; a new data indicator indicative of whether a buffer associated with the source process identifier is to be flushed; or information indicative of redundancy version for the first subset of the source data.

In some embodiments, the second subset of the source data may be transmitted with at least one of: an identifier for the second subset of the source data; information indicative of a location of the second subset of the source data within the source data; information identifying a source process identifier indicative of the source data; a new data indicator indicative of whether a buffer associated with the source process identifier is to be flushed; or information indicative of redundancy version for the second subset of the source data.

In some embodiments, the new data indicator may be indicative of whether the source data is different from source data transmitted, in an immediately preceding transmission, with an identifier that is equal to the source process identifier of the source data.

In some embodiments, the method may further include mapping a first portion of the source data to the first subset of the source data based on importance of the first portion of the source data; and mapping a second portion of the source data to the second subset of the source data based on importance of the second portion of the source data.

In some embodiments, the method may further include configuring an importance criterion to be used for determining the importance of the first portion of the source data and the importance of the second portion of the source data; transmitting the configured importance criterion; and receiving information indicative of whether the importance of the first portion of the source data is greater than the importance of the second portion of the source data.

In some embodiments, the method may further include determining the importance of the first portion of the source data and the importance of the second portion of the source data.

In some embodiments, the method may further include configuring source data information comprising at least one of: a compression ratio for the source data, a first location indicating a location of the first subset of the source data within the source data, a second location indicating a location of the second subset of the source data within the source data, a first compression version associated with the compression ratio, a first compression version indicative of the first location, a second compression version associated with the compression ratio, or a second compression version indicative of the second location.

In some embodiments, the method may further include transmitting information indicative of a specific data to be transmitted by the device, and the information indicative of the specific data may include at least one of a scheduling request or a buffer status report.

In some embodiments, the method may further include receiving scheduling information for transmission of the first subset of the source data; and receiving scheduling information for retransmission of the first subset of the source data or transmission of the second subset of the source data.

According to an aspect of the disclosure there is provided a device including a memory and a processor. The memory is configured to store processor-executable instructions and the processor is configured to execute the processor-executable instructions to cause the device to perform a method consistent with the embodiments described above.

According to an aspect of the present disclosure, there is provided a method performed by a device, for example but not limited to a base station (BS) or a user equipment (UE), for data transmission. The method may include receiving, in a first transmission, first data that is channel encoded. The method may further include transmitting feedback indicating that a further transmission related to the first data is required. The method may further include receiving, in a second transmission, either a retransmission of the first data or second data that is different from the first data.

In some embodiments, at least one of the first data or the second data is source coded or compressed.

In some embodiments, the first data may be a first subset of source data and the second data may be a second subset of the source data that is different from the first subset of the source data.

In some embodiments, the feedback may include at least one of: a channel decoding outcome of the first subset of the source data received in the first transmission; a source decoding outcome associated with the first subset of the source data received in the first transmission; information indicative of a degree of distortion present in the first subset of the source data received in the first transmission after channel decoding of the first subset of the source data; or performance information indicative of performance of source recovery or task execution, where the source recovery or the task execution may be performed using the first subset of the source data received in the first transmission.

In some embodiments, the second transmission may include either the retransmission of the first subset of the source data or the second subset of the source data, depending on the degree of distortion present in the first subset of the source data received in the first transmission after channel decoding of the first subset of the source data.

In some embodiments, the feedback may include the channel decoding outcome and the performance information. The channel decoding outcome may indicate that channel decoding of the first subset of the source data was successful, and the performance information may indicate that the source recovery or task execution failed. In some embodiments, in response, the second transmission includes the second subset of the source data, rather than a retransmission of the first subset of the source data.

In some embodiments, the feedback may include the channel decoding outcome and the information indicative of the degree of distortion. The channel decoding outcome may indicate that channel decoding of the first subset of the source data failed, and the information indicative of the degree of distortion may be below a distortion ratio threshold or within a distortion ratio range. In some embodiments, in response, the second transmission includes the second subset of the source data, rather than a retransmission of the first subset of the source data.

In some embodiments, the feedback may further include the performance information. The performance information may indicate that source recovery or task execution failed.

In some embodiments, the feedback may include the channel decoding outcome only when the performance information indicates that the source recovery or the task execution failed.

In some embodiments, the method may further include receiving a performance criterion to be used for evaluating the performance of the source recovery or the task execution. The performance criterion may be configured by another device transmitting the first subset of the source data or the second subset of the source data. The method may further include evaluating the performance of the source recovery or the task execution based on the received performance criterion.

In some embodiments, the method may further include evaluating the performance of the source recovery or the task execution based on a predetermined performance criterion.

In some embodiments, the information indicative of the degree of distortion may include distortion status information (DSI). The DSI may be determined based on an estimated code block error ratio or an estimated bit error ratio of the first subset of the source data received in the first transmission.

In some embodiments, the first subset of the source data may be received in the second transmission, and the method may further include performing hybrid automatic repeat request (HARQ) with combining the first subset of the source data received in the first transmission and the first subset of the source data received in the second transmission to obtain channel decoded first subset of source data; and performing the source recovery or the task execution using the channel decoded first subset of source data.

In some embodiments, the second subset of the source data may be received in the second transmission, and the method may further include combining the first subset of the source data received in the first transmission and the second subset of the source data received in the second transmission; and performing the source recovery or the task execution using the combined first and second subsets of the source data.

In some embodiments, the method may further include transmitting second feedback comprising at least one of: a channel decoding outcome of the first subset or the second subset of the source data received in the second transmission; a source decoding outcome associated with the first subset or the second subset of the source data received in the second transmission; information indicative of how much distortion is present in the first subset or the second subset of the source data received in the second transmission; or second performance information indicative of performance of the source recovery or the task execution, where the source recovery or the task execution may be performed using the first subset or the second subset of the source data received in the second transmission.

In some embodiments, the second feedback may include the second performance information. The second performance information may indicate success of the source recovery or the task execution. The method may further include receiving information comprising a source process identifier indicative of the source data and an indication triggering flush of a buffer associated with the source process identifier; and flushing the buffer for the source data associated with the source process identifier.

In some embodiments, the second feedback may include the second performance information. The second performance information may indicate success of the source recovery or the task execution, and the method may further include transmitting information comprising a source process identifier indicative of the source data and an indication triggering flush of a buffer for the source data associated with the source process identifier.

In some embodiments, the information indicative of how much distortion is present in the first subset or the second subset of the source data received in the second transmission may include distortion status information (DSI). The DSI may be determined based on an estimated code block error ratio or an estimated bit error ratio of the first subset or the second subset of the source data received in the second transmission.

In some embodiments, the first subset of the source data may be received, in the first transmission or the second transmission, with at least one of: an identifier for the first subset of the source data; information indicative of a location of the first subset of the source data within the source data; information identifying a source process identifier indicative of the source data; a new data indicator indicative of whether a buffer associated with the source process identifier is to be flushed; or information indicative of redundancy version for the first subset of the source data.

In some embodiments, the second subset of the source data may be received, in the second transmission, with at least one of: an identifier for the second subset of the source data; information indicative of a location of the second subset of the source data within the source data; information identifying a source process identifier indicative of the source data; a new data indicator indicative of whether a buffer associated with the source process identifier is to be flushed; or information indicative of redundancy version for the second subset of the source data.

In some embodiments, the new data indicator may be indicative of whether the source data is different from source data transmitted, in an immediately preceding transmission, with an identifier that is equal to the source process identifier of the source data.

In some embodiments, a first portion of the source data may be mapped to the first subset of the source data based on importance of the first portion of the source data, and a second portion of the source data may be mapped to the second subset of the source data based on importance of the second portion of the source data.

In some embodiments, the method may further include receiving an importance criterion to be used for determining the importance of the first portion of the source data and the importance of the second portion of the source data. The importance criterion may be configured by a different device transmitting the first subset of the source data or the second subset of the source data. The method may further include transmitting information indicative of whether the importance of the first portion of the source data is greater than the importance of the second portion of the source data.

In some embodiments, the method may further include determining the importance of the first portion of the source data and the importance of the second portion of the source data.

In some embodiments, the method may further include receiving source data information indicative of at least one of: a compression ratio for the source data, a first location indicating a location of the first subset of the source data within the source data, a second location indicating a location of the second subset of the source data within the source data, a first compression version associated with the compression ratio, a first compression version indicative of the first location, a second compression version associated with the compression ratio, or a second compression version indicative of the second location.

In some embodiments, the method may further include receiving information indicative of a specific data to be received by the device. The information indicative of the specific data may include at least one of a scheduling request or a buffer status report.

In some embodiments, the method may further include scheduling the first transmission and the second transmission; and transmitting scheduling information of the first transmission and the second transmission.

According to an aspect of the disclosure there is provided a device including a memory and a processor. The memory is configured to store processor-executable instructions and the processor is configured to execute the processor-executable instructions to cause the device to perform a method consistent with the embodiments described above.

According to an aspect of the disclosure, there is provided a computer-readable storage medium. The computer-readable storage medium stores instructions that, when executed by a processor of a device, cause the device to perform a method as described above.

By virtue of some aspects of the present disclosure, air interface overhead may be reduced in data transmission between transmitting and receiving devices in wireless communications. For example, by incrementally transmitting data while taking channel and source coding into account as is described in the present disclosure, a receiving device, such as a UE or a BS, may be able to successfully recover source data (e.g., sensing data recovery) or implement a task (e.g., AI inference) while reducing air interface overhead in a wireless communication network.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates a transmitting device communicating with a receiving device, according to some embodiments of the present disclosure;

FIG. 6 illustrates an example process of adaptively transmitting data in consideration of source compression ratio and channel coding rate, in accordance with embodiments of the present disclosure;

FIGS. 7A to 7C illustrate an example of sensing recovery process in a two-dimensional (2D) environment, in accordance with some embodiments of the present disclosure;

FIG. 8A illustrates an example of split artificial intelligence or machine learning (AI/ML) operation between two AI/ML endpoints for a downlink (DL) inference, in accordance with some embodiments of the present disclosure;

FIG. 8B illustrates an example of several candidate split points for an AI/ML operation/model, in accordance with some embodiments of the present disclosure;

FIG. 9 illustrates an example process for transmitting data from a transmit-and-receive point (TRP) to a user equipment (UE), in accordance with some embodiments of the present disclosure;

FIG. 10 illustrates an example of reordering feature maps based on importance, in accordance with some embodiments of the present disclosure;

FIG. 11A illustrates an example of incremental adaptive downlink data transmission based on importance, in accordance with some embodiments of the present disclosure;

FIG. 11B illustrates an example of incremental adaptive downlink data transmission based on index, in accordance with some embodiments of the present disclosure;

FIG. 12A to 12D illustrate an example operation of a UE in various stages of the data transmission of FIG. 9, in accordance with some embodiments of the present disclosure;

FIG. 13 illustrates an example of split AI/ML operation between two AI/ML endpoints for an uplink (UL) inference, in accordance with some embodiments of the present disclosure;

FIG. 14 illustrates an example process for transmitting data from a UE to a TRP, in accordance with some embodiments of the present disclosure;

FIG. 15A illustrates an example of incremental adaptive uplink data transmission based on importance, in accordance with some embodiments of the present disclosure; and FIG. 15B illustrates an example of incremental adaptive uplink data transmission based on index, in accordance with some embodiments of the present disclosure.

Similar reference numerals may have been used in different figures to denote similar components.

### DETAILED DESCRIPTION

In the present disclosure, “local traffic” may include data or messages, e.g., signaling or information, that are communicated across a radio access network (RAN) while the data or messages can be discerned and interpreted by the RAN. For example, the signaling or information might be communicated using a standard protocol or air interface defined by the 3rd Generation Partnership Project (3GPP) RAN. Put another way, the signaling or information may be visible at the RAN, and the format (e.g., data format) and transmission schemes (e.g., data transmission schemes) may be within the scope of the 3GPP standardization. In the next generations of wireless communication networks, such as sixth generation (6G) network, it is contemplated to provide communications of messages within the RAN(s). The messages may be generated at the base station (BS) side and transmitted to the user equipment (UE) side. The messages may be considered “local traffic”.

In the present disclosure, “compression ratio” may refer to a ratio of input uncompressed data size to output compressed data size (i.e., input uncompressed data size/output compressed data size), where the input uncompressed data size is the size of source encoded data with or without lossless compression.

In the present disclosure, “compression ratio” may also or instead refer to data size after compression, according to a compression method (pre-defined or configured), the receiver could know the data size before compression (i.e., uncompressed data size) according to the compression method. Therefore, a ratio of input uncompressed data size to output compressed data size is known by receiver side.

In the present disclosure, “compression ratio” may also or instead refer to data size before compression (i.e., uncompressed data size), according to a compression method (pre-defined or configured), the receiver could know the data size after compression (i.e., compressed data size) according to the compression method. Therefore, a ratio of input uncompressed data size to output compressed data size is known by receiver side.

In the present disclosure, “compression ratio” may also or instead refer to compression method, according to the compression method, the ratio of input uncompressed data size to output compressed data size is known by receiver side.

In the present disclosure, “source compression bits” or “source compression parameters” refers to source bits or parameters that are encoded based on certain source coding schemes or algorithms with a certain compression ratio.

In the present disclosure, “source compression version” or “compression version” indicates all or some subset(s) of source encoded bits or source compression bits. A compression version (CV) may define the location of a subset of the source encoded bits (which may be lossless encoding bits), e.g., a CV may define starting positions within the source encoded bits, ending positions within the source encoded bits, and/or compressed bit locations within the source encoded bits.

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

### Example Communication Systems and Devices

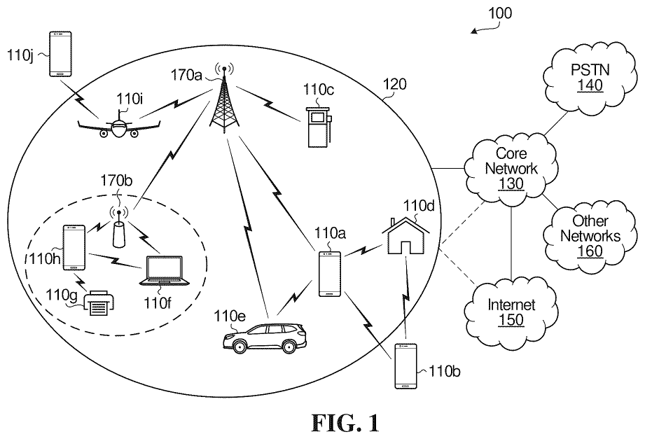

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network.

One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

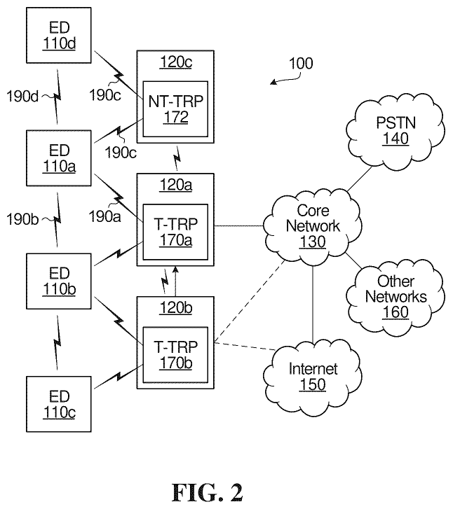

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

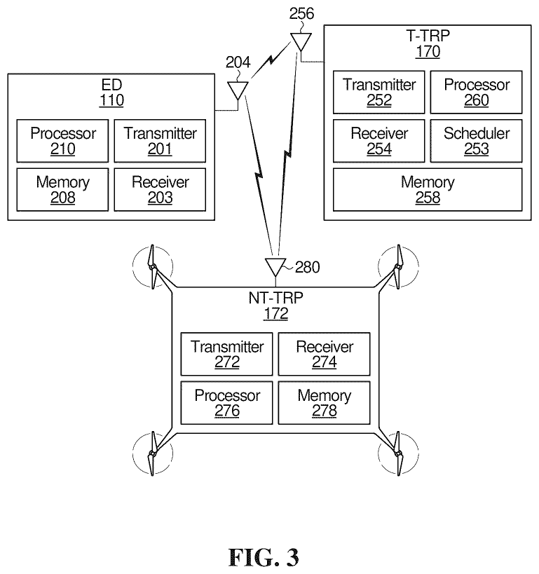

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and may hereafter be referred to as T-TRP 170. Also shown in FIG. 3, a NT-TRP may hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, baseband unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172 , and/or the ED 110 may include other components, but these have been omitted for the sake of clarity.

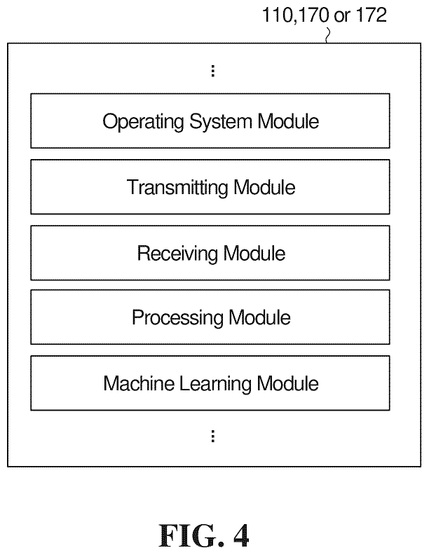

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC control element (CE)). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

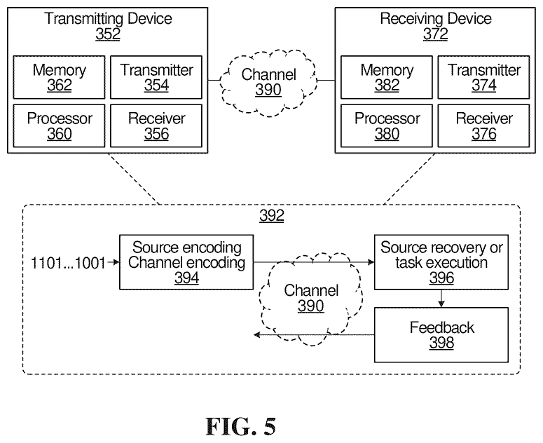

FIG. 5 illustrates a transmitting device 352 communicating with a receiving device 372, according to some embodiments. The term “transmitting device” is used for ease of explanation to refer to the device that, in the examples explained herein, is the device that has information to source encode, channel encode, and transmit. The term “receiving device” is used for ease of explanation to refer to the device that, in the examples explained herein, is the device that receives the channel encoded and source encoded bits from the transmitting device. The transmitting device 352 may still receive communications, e.g., feedback 398 from the receiving device 372. The receiving device 372 may still transmit communications, e.g., feedback 398. For example, the receiving device 372 may transmit feedback 398 which may comprise performance information indicating source recovery (or task execution) outcome back to the transmitting device 352 The feedback 398 may prompt the transmitting device 352 to perform a transmission that comprises a retransmission of some or all of the same subset of source encoded bits that were previously transmitted or a subset of source encoded bits that are different from the subset of bits that were previously transmitted.

In some embodiments, the transmitting device 352 might be, for example, a network device such as a T-TRP or NT-TRP, and the receiving device 372 might be, for example, an electronic device (ED) such as a UE. However, this is not necessary. For example, the opposite may be true, e.g., the transmitting device 352 may be an ED such as a UE, and the receiving device 372 may be a network device such as a T-TRP or NT-TRP. As another example, the transmitting device 352 and the receiving device 372 may be the same type of entity, e.g., two UEs or two TRPs communicating with each other. In some scenarios, the transmitting device 352 and the receiving device 372 might be two entities communicating over a wired channel. The transmitting device 352 and receiving device 372 may be part of a communication system. The communication system may be or include a wireless communication system, e.g., the communication system may be communication system 100 described above.

The transmitting device 352 includes a processor 360, which directly implements or controls the transmitting device 352 to implement the operations of the transmitting device 352 described herein. For example, the processor 360 may perform the source encoding and forward error correction (FEC) parity bit generation described herein. The transmitting device 352 further includes a memory 362 for storing information, e.g., for storing the source encoded bits (e.g., the compressed systematic bits) and the parity bits discussed herein. For example, the memory 362 may implement the HARQ buffer and/or source buffer described herein. The processor 360 may be implemented by a general-purpose processor that executes instructions stored in a memory (e.g., stored in memory 362). Alternatively, the processor 360 may be implemented using dedicated integrated circuitry, such as an ASIC, a GPU, or an FPGA.

The transmitting device 352 further includes a transmitter 354 for preparing and sending transmissions to the receiving device 372 over the channel 390. For example, the transmitter 354 may be implemented by a baseband processor and transmitter chain including a digital-to-analog convertor (DAC), a frequency up-convertor, a power amplifier, and one or more antennas or panels. The processing components of the transmitter 354 (e.g., some or all of a baseband processor) may be implemented by processor 360. The transmitting device 352 further includes a receiver 356 for receiving transmissions from the receiving device 372 over the channel 390. For example, the receiver may be implemented by a receiver chain including one or more antennas or panels, filters, a frequency down-convertor, and an analog-to-digital convertor (ADC), and a baseband processor. The processing components of the receiver 356 (e.g., some or all of a baseband processor) may be implemented by processor 360.

If the transmitting device 352 is T-TRP 170, then the processor 360 may be or include processor 260 and may implement scheduler 253, the memory 362 may be or include memory 258, the transmitter 354 may be or include transmitter 252, and the receiver 356 may be or include receiver 254. If the transmitting device 352 is NT-TRP 172, then the processor 360 may be or include processor 276, the memory 362 may be or include memory 278, the transmitter 354 may be or include transmitter 272, and the receiver 356 may be or include receiver 274. If the transmitting device 352 is ED 110, then the processor 360 may be or include processor 210, the memory 362 may be or include memory 208, the transmitter 354 may be or include transmitter 201, and the receiver 356 may be or include receiver 203.

The receiving device 372 includes a processor 380, which directly implements or controls the receiving device 372 to implement the operations of the receiving device 372 described herein. For example, the processor 380 may perform the source recovery/task execution and/or channel decoding methods described herein and generate feedback 398 which may comprise channel decoding outcome and/or performance information indicating source recovery/task execution. The receiving device 372 further includes a memory 382 for storing information, e.g., for storing the partially channel decoded bits used for HARQ combining. An example of HARQ combining is soft combining such as chase combining or incremental redundancy (e.g., incremental redundancy decoding). The processor 380 may be implemented by a general-purpose processor that executes instructions stored in a memory (e.g., stored in memory 382). Alternatively, the processor 380 may be implemented using dedicated integrated circuitry, such as an ASIC, a GPU, or an FPGA.

The receiving device 372 further includes a transmitter 374 for preparing and sending transmissions to the transmitting device 352 over the channel 390. For example, the transmitter 374 may be implemented by a baseband processor and transmitter chain including a DAC, a frequency up-convertor, a power amplifier, and one or more antennas or panels. The processing components of the transmitter 374 (e.g., some or all of a baseband processor) may be implemented by processor 380. The receiving device 372 further includes a receiver 376 for receiving transmissions from the transmitting device 352 over the channel 390. For example, the receiver may be implemented by a receiver chain including one or more antennas or panels, filters, a frequency down-convertor, and an ADC, and a baseband processor. The processing components of the receiver 376 (e.g., some or all of a baseband processor) may be implemented by processor 380.

If the receiving device 372 is T-TRP 170, then the processor 380 may be or include processor 260 and may implement scheduler 253, the memory 382 may be or include memory 258, the transmitter 374 may be or include transmitter 252, and the receiver 376 may be or include receiver 254. If the receiving device 372 is NT-TRP 172, then the processor 380 may be or include processor 276, the memory 382 may be or include memory 278, the transmitter 374 may be or include transmitter 272, and the receiver 376 may be or include receiver 274. If the receiving device 372 is ED 110, then the processor 380 may be or include processor 210, the memory 382 may be or include memory 208, the transmitter 374 may be or include transmitter 201, and the receiver 376 may be or include receiver 203.

In embodiments explained herein, it is assumed that the transmitting device 352 is transmitting information to the receiving device 372, and therefore the transmitting device 352 implements the encoding operations and the receiving device 372 implements the decoding/source recovery (or task execution) operations and feedback. For example, as shown in stippled bubble 392, the processor 360 of the transmitting device 352 performs at least source encoding and possibly channel encoding 394. If both source encoding and channel encoding 394 are performed, it may be joint source and channel encoding. The output is modulated and sent by transmitter 354 over channel 390 to receiving device 372. The receiver 376 of the receiving device 372 receives the transmission, demodulates and the processor 380 performs channel decoding (if applicable) and source recovery or task execution 396. Feedback 398 such as an indication of source recovery (or task execution) and/or channel decoding outcome may be sent by the transmitter 374 over the channel 390 (e.g., over a feedback channel) to the transmitting device 352 and received via receiver 356. The feedback 398 may trigger the transmitting device 352 to send a further transmission, which may comprise either a retransmission of the same subset of source data or a transmission of a different subset of the source data. The transmitting device 352 may select between the two options in the manner described herein.

In current wireless communications, such as long-term evolution (LTE) or new radio (NR), source coding and channel coding might be separately performed where lossless compression is applied to source coding. Instead, source coding and channel coding can be jointly performed. The joint source channel coding (JSCC; alternatively referred to as joint compression and channel coding) may bring non-trivial enhancement in performance. For example, joint source coding and LDPC channel coding may possibly reach about 2.3 dB gain compared to separate and joint source and channel coding at bit error rate (BER) of 10⁻⁴.

In future wireless communications, such as sixth generation (6G) wireless communication, more applications and use scenarios are expected to involve information resulting from sensing or artificial intelligence (AI) that allows and/or requires real-time or physical source coding and transmission with channel coding. Example scenarios may include sensing data/image transmission for network control, local AI data/model transmission, quality of service (QoS) based extended reality (XR) and virtual reality (VR) services, etc. In such applications and use scenarios, the network may take advantage of JSCC (e.g., physical and/or MAC layers, etc.) to try to optimize source encoding with un-constructed redundancy information and channel coding with constructed redundancy information for possibly more efficient transmissions over varying channels.

Given that more applications and use scenarios are expected to involve transmitting information resulting from sensing or AI in future wireless communications, such as 6G wireless communication, lossy compression might be implemented in the future wireless communications at least for some data transmissions to reduce air interface overhead. For example, joint design for compression ratio and forward error correction (FEC) hybrid automatic repeat request (hybrid ARQ or HARQ) might be implemented to reduce the air interface overhead.

Aspects of the present disclosure provide specific methods and devices for incremental data transmission with channel and source coding, for example using JSCC or implementing the channel and source coding separately. In some aspects of the present disclosure, the source encoding may be implemented and/or performed based on lossy compression, which may require less amount of data transmissions or traffics compared to lossless compression. Transmission of the compressed data (e.g., data generated by a physical layer) may be performed such that when channel decoding and/or source recovery (or task execution) failed, a transmitting device (e.g., transmitting device 352) may perform a further transmission, which may comprise either a HARQ retransmission (e.g., retransmission of data that was incorrectly channel-decoded in the previous transmission) to reduce channel coding rate or an incremental transmission of another data that is different from the previously transmitted data to reduce the compression ratio.

In some aspects of the present disclosure, a network device (e.g., transmit-and-receive point (TRP)) may configure whether to perform either lossless compression or lossy compression for data (or a type of data, e.g., sensing data) to transmit. The data to transmit may be a local traffic data, L1 signaling (e.g., channel state information (CSI), reference signal received power (RSRP) etc.), or media access control (MAC)/radio link control (RLC)/packet data convergence protocol (PDCP) signaling. When the data is compressed using lossy compression, the trade-off between data compression and performance of source recovery (or task execution) may need to be considered. While a larger compression ratio may result in smaller data size, which may further result in less air interface overhead for data exchange across the network, it generally also means poorer performance in source recovery or task execution due to the greater extent of data compression. One example of source recovery is recovery of sensing data. When the sensing data is compressed to a large extent, the sensing resolution (e.g., distance between two points in a point cloud) or sensing accuracy obtained after the source recovery process might be low. One example of task execution is AI inference. When the artificial intelligence or machine learning (AI/ML) model training input or AI/ML model parameters are compressed to a large extent, the accuracy of AI/ML inference might be low.

According to embodiments, there is provided a method for adaptively transmitting data in consideration of source compression ratio and channel coding rate.

In some embodiments, a TRP (e.g., base station (BS)), which may be a transmitting device, may indicate source compression ratio and channel coding rate to a UE, which may be a receiving device. This way, the TRP may transmit certain data to a UE. The data transmitted to the UE may or may not be source encoded (compressed). In one example, the TRP may perform an initial transmission of first data with a large compression ratio. The first data may be a first subset of source data. If channel decoding was successful (regardless of outcome of source recovery or task execution), a retransmission of the first data may not be needed. If channel decoding failed and source recovery or task execution failed, the TRP may perform a retransmission of the first data. However, in some cases (e.g., when the distortion ratio of the received data is lower than a certain threshold), even if channel decoding failed and source recovery or task execution failed, the TRP may (incrementally) transmit to the UE second data that is different from the first data. It may be noted that, if the first data is a first subset of source data, the second data may be a second subset of the source data that is different from the first subset of the source data. The UE, the receiving device, may combine the first data received in the first transmission and the second data received in the second transmission, to correctly perform source recovery or task execution. In the case of the incremental transmission, the UE may obtain a lower compression ratio, as the compression ratio is determined based on the combined first and second data (e.g., combined first and second subsets of the source data).

In some embodiments, transmission of the compressed data (e.g., data generated by a physical layer) may be performed such that when channel decoding or source recovery (or task execution) failed, a transmitting device (e.g., the TRP in the above example) may perform a further transmission, which comprises either a HARQ retransmission to reduce channel coding rate (e.g., retransmission of the first data with more redundancy bits) or a transmission of another data (e.g., the second data) that is different from the previously transmitted data to reduce the compression ratio.

The present disclosure illustrates methods and devices for incremental data transmission with channel and source coding, using several examples where one or more subsets of the same source data are transmitted from a transmitting device to a receiving device. However, it should be noted that the methods and devices illustrated in the present disclosure may be applied to transmission of data that are not subsets of the same data. For example, the methods and devices illustrated in the present disclosure may be applied to transmission of first data and second data that may or may not be subsets of the same source data. Put another way, a first subset of source data may be one example of first data, and a second subset of source data may be one example of second data.

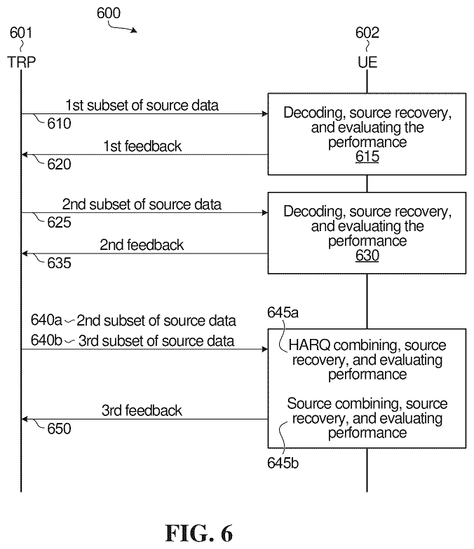

FIG. 6 illustrates an example process 600 of adaptively transmitting data in consideration of source compression ratio and channel coding rate, in accordance with embodiments of the present disclosure. The TRP 601 may be a transmitting device, such as the transmitting device 352 illustrated in FIG. 5, and the UE 602 may be a receiving device such as the receiving device 372 illustrated in FIG. 5. The TRP 601 may transmit source data to the UE 602 and implement encoding operations (e.g., JSCC). The UE 602 may receive the source data from the TRP 601 and implement decoding operations and feedback. The source data transmitted from the TRP 601 to the UE 602 may be split into a plurality of subsets based on importance or other priority. For the purpose of illustration, in the process 600, it is considered that the first subset corresponds to the most important 10% portion of the source data, the second subset corresponds to the next (i.e., second) most important 10% portion of the source data (i.e., 10˜20% in terms of importance), and third subset corresponds to the next (i.e., third) most important 10% portion of the source data (20˜30% in terms of importance).

Step 610 illustrates the first transmission (initial transmission). The TRP 601 in the first transmission may transmit the first subset of the source data to the UE 602. The first subset of the source data to be transmitted by the TRP 601 may be source encoded. In some embodiments, the TRP 601 may select the first subset of the source data to transmit to the UE 602, and then perform source coding on the first subset of the source data. In some other embodiments, the TRP 601 may perform source coding on the source data, and then select the first subset to transmit to the UE 602 among the source encoded source data (source encoded bits). In some embodiments, there may not be difference in priority between source encoded bits. In some embodiments, there may be difference in priority between source encoded bits, and the most important source encoded bit(s) might be selected to transmit to the UE 602 in the first transmission.

The source compression ratio may be 10 (i.e., 100%/10%), as the only first subset of the source data is transmitted. In some embodiments, the compression ratio may be predetermined or configured by the TRP 601. The TRP 601 may perform channel encoding on the first subset of the source data.

After receiving the first subset of the source data, the UE 602 at step 615 may perform source recovery and/or channel decoding for the first subset of the source data. In some embodiments, the UE 602 may always perform source recovery regardless of the outcome of the channel decoding. Just for the purpose of illustration, at step 615, the channel decoding is correctly performed but the source recovery failed.

After the source recovery, at step 620, the UE 602 may transmit, to the TRP 601, the first feedback comprising the outcome of the source recovery and/or the channel decoding. In some embodiments, the outcome of the source recovery and/or the outcome of the channel decoding may be in the form of an acknowledgement (ACK) or a negative acknowledgement (NACK). In this example, the outcome of the source recovery in the first feedback may be in the form of a NACK and the outcome of the channel decoding in the first feedback may be in the form of an ACK.

Step 625 illustrates the second transmission. In the second transmission, the TRP 601 may transmit the second subset of the source data to the UE 602. The TRP 601 may perform source encoding on the second subset of the source data. The combined compression ratio may be 5 (i.e., 100%/(10+10)%), as the first and second subsets of the source data have been transmitted.

After receiving the second subset of the source data, the UE 602 at step 630 may perform source recovery and/or channel decoding for the second subset of the source data. Just for the purpose of illustration, at step 630, both of the channel decoding and the source recovery failed.

After the source recovery, at step 635, the UE 602 may transmit, to the TRP 601, the second feedback comprising the outcome of the source recovery and/or the channel decoding. As both of the channel decoding and the source recovery failed, the outcome of the source recovery and the outcome for each of the channel decoding in the second feedback may be in the form of a NACK.

Steps 640a and 640b are two options for the third transmission. In the first option, which corresponds to step 640a, the TRP 601 may retransmit the second subset of the source data to the UE 602. In the first option, the combined compression ratio may stay at 5. In the second option, which corresponds to step 640b, the TRP 601 may transmit the third subset of the source data to the UE 602. In the second option, the combined compression ratio may be further reduced to 3.33 (i.e., 100%/(10+10+10)%), as the first, second, and third subsets of the source data have been transmitted. The second option may be referred to as incremental transmission.

If the UE 602 receives the second subset of the source data (i.e., if step 640a is performed), the UE 602, at step 645a, may perform source recovery and/or channel decoding for the second subset of the source data. Regarding the channel decoding, the UE 602 may perform HARQ combining channel decoding (e.g., incremental redundancy), combining the second subset of the source data in the second transmission (i.e., step 625) with the second subset of the source data in the third transmission (i.e., step 640a). The channel coding rate may be decreased due to the HARQ combining. The UE 602 may correctly decode the codeword for the second subset of the source data. Regarding the source recovery, the UE 602 may perform source recovery using the first and second subsets of the source data.

If the UE 602 receives the third subset of the source data (i.e., if step 640b is performed), the UE 602, at step 645b, may perform source recovery still using the second subset of the source data that is transmitted in the second transmission at step 625 and is distorted due to the channel decoding failure at step 630. The second subset of the source data transmitted in the second transmission may be used in the source recovery because the distorted data may still have some valuable information. For the source recovery, the UE 602 may perform source recovery using the first, second, and third subsets of the source data. As noted above, the second subset of the source data used for the source recovery may be distorted due to the earlier channel decoding failure.

At step 650, the UE 602 may transmit, to the TRP 601, the third feedback comprising the outcome of the source recovery and/or the channel decoding, in the same manner as illustrated in steps 620 and 635.

In a variation of FIG. 6, instead of source recovery, task execution using the received bits may be performed by the UE 602, and the feedback may include the outcome of the task execution instead of the outcome of source recovery.

According to some embodiments, when the channel decoding of a certain subset of the source data failed at a receiving device, whether the same subset of the source data is retransmitted or a different subset of the source data is transmitted by a transmitting device in the subsequent transmission may be determined based on the distortion ratio (or channel decoding distortion ratio) of the subset of the source data for which the channel decoding failed at the receiving device. For example, if the distortion ratio (or channel decoding distortion ratio) of the subset of the source data for which the channel decoding failed is not high (e.g., distortion ratio is below a certain distortion ratio threshold or within a distortion ratio range), the transmitting device may transmit another subset of the source data that is different from the subset of the source data for which the channel decoding failed. In other words, incremental transmission of the different subset of the source data that might reduce the compression ratio may be more beneficial than the HARQ combining channel decoding.

As described above, source recovery may be performed at a receiving device for a subset of source data received from a transmitting device, and performance of the source recovery (e.g., whether the source recovery was correctly performed) is transmitted to the transmitting device as part of a feedback. In some cases, certain tasks may be executed at a receiving device for a subset of source data received from a transmitting device, and performance of the task execution (e.g., whether the task was successfully executed) is transmitted to the transmitting device as part of a feedback. In some embodiments, performance of the source recovery and/or the task execution may be evaluated by a receiving device.

In some embodiments, to evaluate the performance of the source recovery or the task execution, a performance criterion may be predetermined or configured by a TRP. The performance criterion may be used to determine whether the source recovery or the task execution is correctly or successfully performed (e.g., Source ACK/NACK or Task ACK/NACK). In one example, when sensing data recovery is performed as the source recovery, the source recovery may be considered to be successfully performed (e.g., Source ACK) if the sensing resolution expressed by recovered sensing data is greater than a certain threshold (e.g., source resolution threshold, source accuracy threshold). Otherwise, the source recovery may be considered as failure (e.g., Source NACK). In another example, when AI/ML inference is performed as the task execution, the task execution may be considered as success (e.g., Task ACK) if accuracy of the AI/ML inference is greater than a certain threshold (e.g., inference accuracy threshold, uncertainty threshold). Otherwise, the task execution may be considered as failure (e.g., Task NACK).

In some embodiments, a UE may report requirements for the source recovery or the task execution. The requirement for the source recovery may be the source resolution threshold or source accuracy threshold. The requirement for the task execution may be the inference accuracy threshold or uncertainty threshold. The UE may transmit the source recovery or task execution requirements to the TRP before transmission of the source data. The TRP may determine the performance criterion based on the source recovery or task execution requirements reported by the UE.

As mentioned earlier, one example of source recovery is recovery of sensing data. In future wireless communications, such as 6G wireless communication, applications or use scenarios may involve information (e.g., traffic) resulting from sensing. For example, three-dimensional (3D) environment reconstruction may be utilized in many applications using sensing data or sensing signals. The 3D environment reconstruction may be implemented using an ultra-dense 3D point cloud. A point cloud is a discrete (possibly large) set or collection of data points plotted in 3D space. The set of data points may represent a 3D shape or object. The points in the point cloud may be represented based on a given coordinate system (e.g., Cartesian coordinate system). In other words, the position of each point may be represented for example in the Cartesian coordinates (x, y, z). Each data point may be associated with one or more physical dimensions (e.g., angle, range, Doppler parameters). The 3D environment reconstruction may be implemented by performing sensing, for example, using radio frequency (RF) signals. The RF sensing technology may be more effective than conventional sensing technologies that uses cameras or laser measurements, due to its larger sensing range and relatively low complexity.

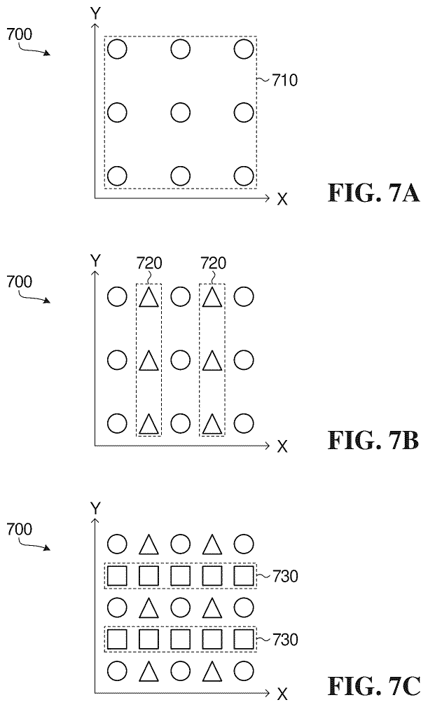

As mentioned above, the problem related to air interface overhead may be worse when applications and use scenarios involve information (e.g., traffic) resulting from sensing because sensing may allow or require real-time physical source coding and transmission with channel coding. As such, lossy compressed data transmission may be desired or needed for sensing data points (3D or 2D) to reduce the air interface overhead. An example of sensing recovery process in a 2D environment 700 is illustrated in FIGS. 7A to 7C, in accordance with some embodiments of the present disclosure. As illustrated in FIG. 7A, the data points 710 may be transmitted in the first transmission and used to reconstruct the 2D environment 700. The data points 710 may only be a small subset of the sensing source data, e.g., 10% resulting in a compression ratio of 10. In FIG. 7A, the data points 710 may be considered sparse points as the distance between the two data points 710 is large. After the transmission of the data points 710, sensing data recovery may be performed as the source recovery. The sensing recovery associated with FIG. 7A may be considered as failure (e.g., Source NACK), as the sensing result (e.g., sensing resolution) after the sensing recovery does not meet a certain requirement. For example, sensing resolution, which may indicate separation between multiple objects/positions in terms of range, angle, velocity, etc., is lower than a source resolution threshold that may be predetermined or configured by a TRP.

As the sensing recovery in FIG. 7A failed, additional data points 720 (e.g., a different subset of the sensing source data) may be transmitted and used to reconstruct the 2D environment 700, as is described in FIG. 7B. Due to the additional data points 720, the 2D environment 700 in FIG. 7B is now denser than the 2D environment 700 in FIG. 7A, and the distance between the two adjacent data points of FIG. 7B is shorter than that of FIG. 7A. After the transmission of the data points 720, sensing data recovery may be performed as the source recovery. The sensing recovery associated with FIG. 7B may still fail (e.g., Source NACK), as the sensing result (e.g., sensing resolution) after the sensing recovery does not meet the requirement. For example, the sensing resolution is increased in FIG. 7B but still lower than the source resolution threshold.

As the sensing recovery in FIG. 7B failed, further data points 730 may be transmitted and used to reconstruct the 2D environment 700, as is described in FIG. 7C. Due to the further data points 730, the 2D environment 700 in FIG. 7C may be considered dense, and the distance between the two adjacent data points in FIG. 7C is shorter than that in FIG. 7A or FIG. 7B. After the transmission of the data points 730, sensing data recovery may be performed as the source recovery. The sensing recovery associated with FIG. 7C is considered success (e.g., Source ACK), as the sensing result (e.g., sensing resolution) after the sensing recovery meets the requirement. For example, the sensing resolution in FIB. 7C is increased and greater than the source resolution threshold.

The source recovery process illustrated in FIGS. 7A to 7C is one use case related to recovery of sensing data. It should be noted that embodiments of the present disclosure may be used in other use cases related to the RF based sensing technologies, such as cases for high accuracy localization, gesture and activity recognition, and non-RF based sensing (e.g., video surveillance where lossy compression may be used for the images/videos; here, the quality of the received images/videos may correspond to the sensing resolution).

As mentioned earlier, one example of task execution is AI/ML inference. Examples for AI/ML inference are provided below and elsewhere in the present disclosure.

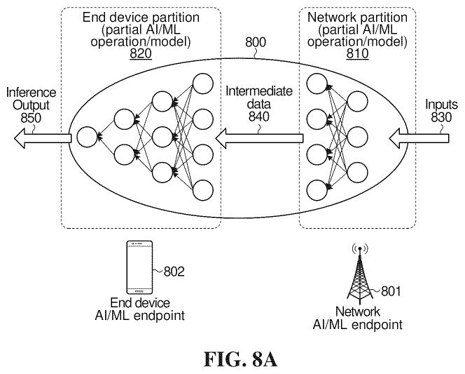

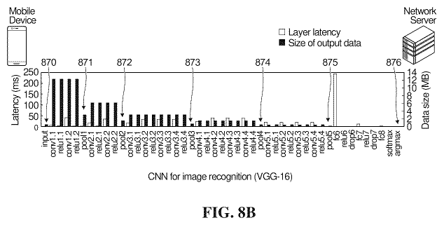

FIG. 8A illustrates an example of split artificial intelligence or machine learning (AI/ML) operation between two AI/ML endpoints for a downlink (DL) inference. Referring to FIG. 8A, the AI/ML model 800 may be split into two partitions. The network side partition of the AI/ML model 800 may be the partial AI/ML model 810, and the end device side partition of the AI/ML model 800 may be the partial AI/ML model 820.

The training of the AI/ML model 800 may be split into two parts. The training of the partial AI/ML model 810, which may include computation-intensive and/or energy-intensive parts of the AI/ML model training, may be performed at the network AI/ML endpoint 801 (e.g., TRP). The training of the partial AI/ML model 820, which may include privacy-sensitive and delay-sensitive parts of the AI/ML model training, may be performed at the end device AI/ML endpoint 802 (e.g., UE). As the split AI/ML inference described in FIG. 8A is a DL inference, the network AI/ML endpoint 801 may take the inputs 830 and perform specific part or layers of the AI/ML model training, which corresponds to the training of the partial AI/ML model 810, using the inputs 830. After the training of the partial AI/ML model training 810 is complete, the network AI/ML endpoint 801 may transmit the intermediate data 840 or the output of the training of the partial AI/ML model 810 to the end device AI/ML endpoint 802. The end device AI/ML endpoint 802 may receive the intermediate data 840 and perform the other part or layers of the AI/ML model training, which corresponds to the training of the partial AI/ML model 820, using intermediate data 840 as input. The end device AI/ML endpoint 802 may obtain the inference output 850 after the training of the partial AI/ML model 820, and possibly transmit the inference output 850 back to the network AI/ML endpoint 801.

In connection with the data transmission method described in the present disclosure, the intermediate data 840 may be the source data exchanged between two devices (e.g., TRP, UE) across the network. This intermediate data 840 may be generated during training or during use post-training.

FIG. 8B illustrates an example of several candidate split points for training of the AI/ML model 800. As shown in FIG. 8B, there are a plurality of candidate split points 870 to 876 for the AI/ML model. In this specific illustrated example, the AI/ML model may be a convolutional neural network (CNN) for image recognition or a visual geometry group (VGG)-16 model. For split AI/ML model training, one of the candidate split points 870 to 876 may be selected as a split point. Given that the AI/ML model in this example is a VGG-16 model, the intermediate data to be exchanged between two AI/ML endpoints may be multiple feature maps, where each feature map is a 2D matrix and each node takes one feature map. The number of feature maps included in the intermediate data may be different, depending on the selected split point. For example, while there may be 128 feature maps for the split point 872 (and accordingly 128 nodes at the split point 872), there may be different number of feature maps for other split points (and different number of nodes accordingly).

Regarding the output of the last layer of the partial AI/ML model trained at the network AI/ML endpoint, the indices for the output data may be predetermined or configured, for example, by selecting a split point. For example, when the candidate split point 872 is selected as a split point, the output of the last layer of the partial AI/ML model trained at the network AI/ML endpoint side (transmitting device in a DL inference) is 128 feature maps. Assuming that each feature map has an index, the indices 1 to 128 may be used for the output of the last layer of the partial AI/ML model. In other words, the feature maps may be indexed from 1 to 128, for example from the top to the bottom of the last layer of the partial AI/ML model trained at the network AI/ML endpoint.

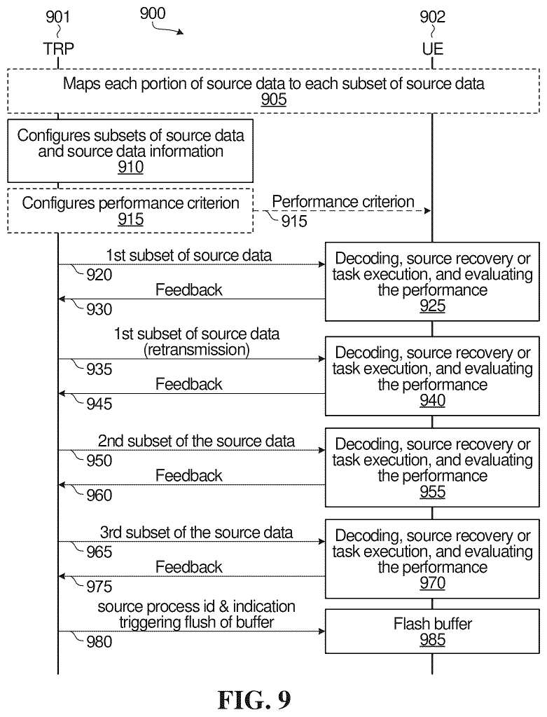

FIG. 9 illustrates an example process 900 for transmitting data from a transmit-and-receive point (TRP) to a user equipment (UE), in accordance with some embodiments of the present disclosure. The TRP 901 may be a transmitting device (e.g., transmitting device 352 illustrated in FIG. 5) and implement encoding operations (e.g., JSCC). The UE 902 may be a receiving device (e.g., receiving device 372 illustrated in FIG. 5) and implement decoding operations and feedback. In some embodiments, the TRP 901 may be a network AI/ML endpoint and transmit intermediate data (e.g., intermediate data 840 in FIG. 8A) or output of training of a partial AI/ML model trained at the TRP 901, and the UE 902 may be an end device AI/ML endpoint and perform DL AI/ML inference using the intermediate data received from the TRP 901. In the example process 900, the source data transmitted from the TRP 901 to the UE 902 may be intermediate data, which is an output of the partial AI/ML model trained at the TRP 901. The intermediate data transmitted from the TRP 901 to the UE 902 may be 128 feature maps illustrated above. The intermediate data is an example of the source data. More generally, the source data is the data to be used by the receiving device (UE 902) to perform a source recovery or task execution, where the source recovery or task execution may be successful or at least good enough without necessary all the source data, hence the transmission of only subsets of the source data to try to reduce air interface overhead.

At step 905, which is an optional step, the TRP 901 or the UE 902 may map each portion of the source data to each subset of the source data, for example, based on importance of respective portion of the source data. In other words, the TRP 901 or the UE 902 may map a first portion of the source data to a first subset of the source data based on importance of the first portion of the source data, a second portion of the source data to a second subset of the source data based on importance of the second portion of the source data, . . . , etc. The first portion of the source data may be the most important data portion in connection with AI/ML performance, and the second portion of the source data may be the second most important data portion in connection with AI/ML performance.

In some embodiments, the TRP 901 may configure an importance criterion to be used for determining the importance of the first portion of the source data and the importance of the second portion of the source data. The TRP 901 may transmit, to the UE 902, the configured importance criterion, and receive, from the UE 902, information indicative of priority of each portion of the source data in terms of their importance (e.g., information indicating that the importance of the first portion of the source data is greater than the importance of the second portion of the source data, and the importance of the second portion of the source data is greater than the importance of the third portion of the source data, etc.).

In some embodiments, the TRP 901 may determine importance of each portion of the source data (e.g., the importance of the first portion of the source data, the importance of the second portion of the source data, . . . etc.) based on for example an internal algorithm of the TRP 901.

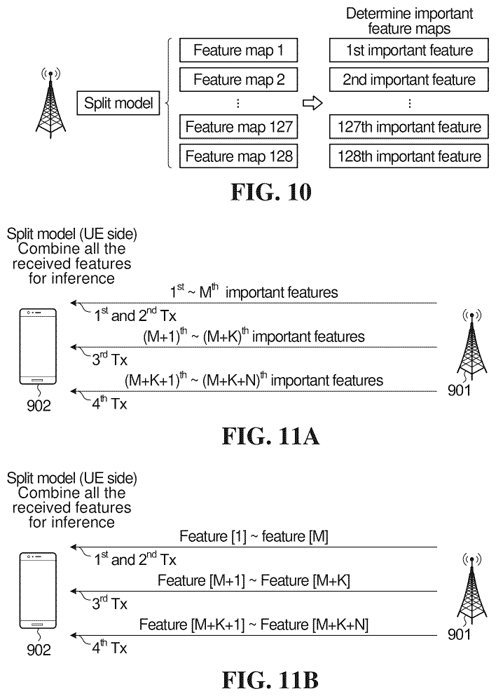

In some embodiments where the source data comprises 128 feature maps, which may be indexed from 1 to 128 from the top to the bottom of the last layer of the partial AI/ML model trained at the TRP 901, the TRP 901 or the UE 902 may reorder the feature maps according to their importance in connection with performance (e.g., AI/ML inference accuracy), as is illustrated in FIG. 10. As shown in FIG. 10, the 128 feature maps indexed 1 to 128 are reordered based on the importance of each feature map, from the most important feature map (e.g., 1^{st} important feature map) to the least important feature map (e.g., 128^{th} important feature map).

To determine importance of each portion of the source data (e.g., importance of each feature map), the TRP 901 may observe the effect of a compression ratio to the AI/ML inference outcome in combination with different feature maps during AI/ML model training. Alternatively, the TRP 901 determine importance of each feature map by L1 normalization of a filter connected to the feature map (e.g., calculate the sum of absolute value of parameters in the filter connected to the feature map). A larger L1-normalization value means that the connected feature map is more important.

In some embodiments, the TRP 901 or the UE 902 may map each portion of the source data to each subset of the source data regardless of importance of each portion of the source data. For example, in some embodiments where the source data comprises 128 feature maps, which may be indexed from 1 to 128 from the top to the bottom of the last layer of the partial AI/ML model trained at the TRP 901, the TRP 901 may randomly choose the features to transmit or may select the features to transmit based on a predetermined rule (e.g., based on indices of the features, for example in order of increasing indices of the features, i.e., the feature with the lowest index is transmitted first, and the feature with the highest index is transmitted last).

Returning to FIG. 9, at step 910, the TRP 901 may configure a plurality of subsets of the source data to transmit to the UE 902. Each subset of the source data may be channel encoded and/or possibly source encoded (e.g., lossless source encoding may have been applied to the source data). Each subset of the source data may include one or more source encoded bits or a subset of source parameters. In some embodiments where the source data comprises 128 feature maps, each subset of the source data may comprise N feature maps (N≤128) and may have an index, which may be configured by the TRP 901.

The TRP 901, at step 910, may also configure source data information, which may include at least one of a compression ratio for the source data, location information indicating a location of each subset of the source data within the source data, a compression version associated with the compression ratio, or a compression version indicative of the location information.

In some embodiments, the TRP 901 may configure a compression ratio for the source data, and optionally configure a compression version. The compression version may be associated with the compression ratio and/or indicative of location of each subset of the source data within the source data. In some embodiments, the TRP 901 may configure multiple compression versions at one time.

In some cases, a compression ratio may be associated with multiple compression versions. For example, when a compression ratio is 2 for the source data having 128 feature maps, the compression ratio may be associated with two different compression versions. The first compression version may indicate a subset of the source data including the feature maps that are indexed from 1 to 64. The second compression version may indicate a subset of the source data including the feature maps that are indexed from 65 to 128. In another example, when a compression ratio is 2 for the source data having 128 feature maps, the compression ratio may be associated with three different compression versions. The first compression version may indicate a subset of the source data including the feature maps that are indexed from 1 to 64. The second compression version may indicate a subset of the source data including the feature maps that are indexed from 33 to 97. The third compression version may indicate a subset of the source data including the feature maps that are indexed from 65 to 128. It should be noted that two subsets of the source data that are associated with two different compression versions may have overlapping portions of source data bits (e.g., overlapping feature maps).

In some embodiments, the number of compression versions may be predetermined or configured by the TRP 901. The subset of the source data associated with each compression version may be predetermined or configured by the TRP 901. For example, for source data having 128 feature maps, which feature maps are associated with a certain compression version may be predetermined or configured by the TRP 901.

In some embodiments, the TRP 901 may configure a location of each subset of the source data within the source data, or location information indicating a location of each subset of the source data within the source data. In one example where the source data includes 128 feature maps that are indexed from 1 to 128, the TRP 901 may configure a subset of the source data (or determine which feature maps of the 128 feature maps are included in that subset of the source data) using a 128-bit bitmap (e.g., feature maps that are corresponding to bits with a value ‘1’ are included in the subset of the source data, where each bit of the 128-bit bitmap corresponds to a feature map). In another example where the source data includes 128 feature maps that are indexed from 1 to 128, the TRP 901 may configure a subset of the source data (or determine which feature maps of the 128 feature maps are included in that subset of the source data) using an index set {map_index_i, . . . , map_index_m} (e.g., feature maps whose indices are in the index set {map_index_i, . . . , map_index_m} are included in the subset of the source data).

At step 915, which is an optional step, the TRP 901 may configure a performance criterion to be used for evaluating the performance of source recovery or task execution. The TRP 901 may transmit the configured performance criterion to the UE 902 so that the UE 902 may use the configured performance criterion when evaluating the performance of the source recovery or the task execution. For example, when AI/ML inference is performed as the task execution, the task execution may be considered as success (e.g., Task ACK) if accuracy of the AI/ML inference is greater than a certain threshold (e.g., inference accuracy threshold, uncertainty threshold). Otherwise, the task execution may be considered as failure (e.g., Task NACK).

In some embodiments, the UE 902 may report requirements for the source recovery or the task execution. The requirement for the source recovery may be the source resolution threshold or source accuracy threshold. The requirement for the task execution may be the inference accuracy threshold or uncertainty threshold. The UE 902 may transmit the source recovery or task execution requirements to the TRP 901 before transmission of the source data. The TRP 901 may determine the performance criterion based on the source recovery or task execution requirements reported by the UE 902.

In some embodiments, the performance criterion may be predetermined. In this case, the UE 902 may use the predetermined performance criterion when evaluating the performance of the source recovery or the task execution.

At step 920, the TRP 901 may schedule a first transmission to the UE 902 and transmit a first subset of the source data to the UE 902 in the first transmission. The first subset of the source data may be transmitted with at least one of an identifier for the first subset of the source data (e.g., index of the first subset of the source data), information indicative of a location of the first subset of the source data within the source data, information identifying a source process identifier indicative of the source data (e.g., source process identifier=M), a new data indicator (NDI) indicative of whether a buffer associated with the source process identifier is to be flushed, or information indicative of redundancy version for the first subset of the source data. The NDI may be indicative of whether the source data is different from source data transmitted, in a preceding transmission (e.g., an immediately preceding transmission), with an identifier that is equal to the source process identifier of the source data.

In some embodiments, the total number of the source process identifier may be configured by the TRP 901. For example, the TRP 901 may configure that there are 16 source process identifiers (e.g., ID_0 to ID_15), and assign a specific source process identifier for each transmission.

When the same source process identifier is associated with two different source data, the NDI may be used to distinguish these two different source data. For example, when the NDI is toggled, the source data transmitted is different from source data that was transmitted in a preceding transmission (e.g., immediately preceding transmission). Otherwise, i.e., the NDI is not toggled, two subsets transmitted in two different transmissions are from the same source data, regardless of whether the two subsets are the same subset or different subsets. It should be noted that, in some embodiments, the toggled NDI and untoggled NDI may be used in a manner opposite to the above example (e.g., toggled NDI indicates transmission of the same source data, and untoggled NDI indicates transmission of different source data).

In some embodiments, each source recovery or task execution process may be associated with a certain source buffer. The UE 902 may store the decoded subset of the source data in the associated source buffer and flush the buffer when the NDI indicates that the source data is new (e.g., when the NDI is toggled).

In some embodiments, the TRP 901 may indicate a redundancy version for the first subset of the source data to the UE 902. For example, the TRP 901 may inform the UE 902 that a redundancy version for the first subset of the source data is RV0, as shown in FIGS. 11A-11D described later.

At step 925, after receiving the first subset of the source data from the TRP 901, the UE 902 may perform a channel decoding (and possibly a source decoding) for the received first subset of the source data and perform source recovery or task execution using the channel and/or source decoded first subset of the source data.

Then, the UE 902, at step 930, may transmit, to the TRP 901, feedback including a channel decoding outcome of the first subset of the source data received in the first transmission, a source decoding outcome associated with the first subset of the source data received in the first transmission, and/or performance information indicative of the performance of the source recovery or the task execution. In some embodiments, the performance information may be an acknowledgement indicating success of the source recovery or the task execution or a negative acknowledgement indicating failure of the source recovery or the task execution, depending upon the implementation.

In some embodiments, when the source recovery or task execution failed, the feedback reported by the UE 902 may include the performance information indicating that the source recovery or task execution failed. In some embodiments, the performance information may include source recovery or task execution status information indicative of the current performance of source recovery or task execution (e.g., accuracy, uncertainty). The feedback may also include the channel decoding outcome (e.g., cyclic redundancy check (CRC)) for this transmission (i.e., transmission of step 920) to indicate whether the channel decoding was successful. On the other hand, when the source recovery or task execution was successfully or correctly performed, the feedback may or may not include the channel decoding outcome. In some embodiments, the channel decoding outcome may be not included in the feedback to reduce the air interface overhead when the source recovery or task execution was successfully or correctly performed. In other words, the channel decoding outcome may be included in the feedback only when the performance information indicates that the source recovery or the task execution failed.

In some embodiments, the performance information (e.g., source recovery or task execution status information) may assist the TRP 901 in making a scheduling decision. In one example, the TRP 901 may determine whether to retransmit the first subset of the source data or transmit a second subset of the source data that is different from the first subset of the source data, based on the performance of the source recovery or the task execution. For example, when the AI/ML inference accuracy (i.e., performance of the task execution) is 20% and the target inference accuracy threshold is 90%, the TRP 901 may retransmit the first subset of the source data, due to large discrepancy between the performance and the target inference accuracy threshold. However, when the AI/ML inference accuracy (i.e., performance of the task execution) is 80% and the target inference accuracy threshold is 90%, the TRP 901 may transmit a second subset of the source data that is different from the first subset of the source data, i.e., incremental transmission, although the performed AI/ML inference did not meet the target inference accuracy threshold.

In some embodiments, the feedback may include information indicative of a degree of distortion present in the first subset of the source data (transmitted in step 920) after channel decoding of the first subset of the source data. In some embodiments, the information indicative of the degree of distortion may include distortion status information (DSI). The DSI may be determined based on an estimated code block error ratio or an estimated bit error ratio of the first subset of the source data transmitted at step 920. In some embodiments, the information indicative of the degree of distortion may include statistical characteristic over a predetermined time window (e.g., decoding performance in recent m slots or decoding performance of the recent n times).

In some embodiments, the TRP 901 may determine whether to retransmit the first subset of the source data or transmit a second subset of the source data that is different from the first subset of the source data, depending on the degree of distortion present in the first subset of the source data transmitted at step 920 after channel decoding of the first subset of the source data. For example, if the degree of distortion is relatively high, for example higher than a distortion ratio threshold or outside of a certain distortion ration range, the TRP 901 may retransmit the first subset of the source data. On the other hand, if the degree of distortion is relatively low, for example below a distortion ratio threshold or within a certain distortion ration range, the TRP 901 may transmit a second subset of the source data that is different from the first subset of the source data. In some cases, if the degree of distortion is relatively low, the TRP 901 may transmit the second subset of the source data, even though channel decoding of the first subset of the source data failed (and the source recovery or the task execution also failed). The distortion ratio threshold and/or the distortion ration range may be predetermined or configured by the TRP 901 using the internal algorithm of the TRP 901.

In some embodiments, when the TRP 901 retransmits the first subset to the UE 902, the UE 902 may perform hybrid automatic repeat request (HARQ) with combining the first subset of the source data initially transmitted (in step 920) and the first subset of the source data that is retransmitted (in step 935), to obtain a lower channel coding rate. When the second subset (i.e., a different subset) is transmitted, the UE 902 may combine the first subset of the source data transmitted in a preceding transmission and the second subset of the source data transmitted in a subsequent transmission, to obtain a lower compression ratio. This will be also illustrated below or elsewhere in the present disclosure.

In response to the feedback received at step 930, the TRP 901, at step 935, may schedule a second transmission to the UE 902 and perform the second transmission. Assuming that the feedback received at step 930 includes information indicating that the degree of distortion present in the first subset of the source data transmitted at step 920 was relatively high, the TRP 901 may retransmit the first subset of source data that was previously transmitted at step 920 in the second transmission. This is the example scenario illustrated in FIG. 9. The TRP 901 may determine to retransmit the first subset in the second transmission, based on the feedback and/or an internal algorithm of the TRP 901. The TRP 901 may retransmit the first subset with a different redundancy version, e.g., RV2. The manner in which the TRP 901 retransmits the first subset of the source data may be similar to the manner of transmission at step 920.

At step 940, after receiving the first subset of the source data retransmitted from the TRP 901, the UE 902 may perform a channel decoding (and possibly a source decoding) for the retransmitted first subset of the source data. Then, the UE 902 may perform source recovery or task execution using the first subset of the source data that is channel and/or source decoded. As noted above, as the first subset of source data was retransmitted, the UE 902 may perform HARQ with combining the first subset of the source data transmitted at step 920 and the first subset of the source data retransmitted at step 935 (e.g., combining RV0 and RV2). The channel coding rate may be lowered, due to the HARQ combining. For the purpose of illustration, it is assumed that the channel decoding of the first subset of the source data was successful (i.e., channel decoding was correct) and the source recovery or task execution failed.

At step 945, the UE 902 may transmit feedback to the TRP 901. The feedback may include the outcome of the channel decoding performed at step 940 (e.g., HARQ ACK) and the performance information indicating that the performance of the source recovery or the task execution failed at step 940 (e.g., Source NACK). The feedback may further include, in some embodiments, other information in the similar manner as step 930. For example, the feedback may further include a source decoding outcome and/or information indicative of a degree of distortion (e.g., information indicative of how much distortion is present in the first subset transmitted at step 935, DSI).

In response to the feedback received at step 945, the TRP 901, at step 950, may schedule a third transmission to the UE 902 and perform the third transmission. Based on the feedback received at step 945 indicating that channel decoding of the first subset of source data was successful and/or an internal algorithm of the TRP 901, the TRP 901 may transmit a second subset of the source data that is different from the first subset of the source data in the third transmission. The TRP 901 may transmit the second subset with an initial redundancy version, e.g., RV0. The TRP 901 may also transmit information identifying the same source process identifier (e.g., source process identifier=M) as the previous transmissions at steps 920 and 935. The manner in which the TRP 901 transmits the second subset of the source data may be similar to the manner in which the first subset of the source data is transmitted at steps 920 and 935. For example, the second subset of the source data may be transmitted with at least one of an identifier for the second subset of the source data (e.g., index of the second subset of the source data), information indicative of a location of the second subset of the source data within the source data, information identifying a source process identifier indicative of the source data (e.g., source process identifier=M), a new data indicator (NDI) indicative of whether a buffer associated with the source process identifier is to be flushed, or information indicative of redundancy version for the second subset of the source data.

At step 955, after receiving the second subset of the source data from the TRP 901, the UE 902 may perform a channel decoding (and possibly a source decoding) for the second subset of the source data. For the purpose of illustration, it is assumed that the channel decoding of the second subset of the source data failed (e.g., channel decoding NACK). Then, as the second subset of the source data received in this transmission is different from the first subset of the source data received in the previous transmissions, the UE 902 may combine the first subset of the source data and the second subset of the source data, and perform the source recovery or the task execution using the combined first and second subsets of the source data. The compression ratio may be lowered due to the combining of the first and second subsets of the source data. Here, the first subset of the source data is correctly decoded one, and the second subset of the source data is distorted one. One example of combining is generating the inference using as input to the UE-side neural network the features represented by the first subset of source data (correctly channel decoded) and also the features represented by the second subset of source data (distorted because channel decoding failed). For the purpose of illustration, it is assumed that the source recovery or task execution also failed at step 955, e.g., the inference accuracy was not high enough.

At step 960, the UE 902 may transmit feedback to the TRP 901, in the same manner as steps 930 and 945. The feedback may include the outcome of the channel decoding performed at step 955 (e.g., channel decoding NACK) and the performance information indicating that the performance of the source recovery or the task execution failed at step 955 (e.g., Source NACK, source recovery or task execution status information). The feedback may further include, in some embodiments, other information in the similar manner as steps 930 and 945. For example, the feedback may further include a source decoding outcome and/or information indicative of a degree of distortion (e.g., information indicative of how much distortion is present in the second subset transmitted at step 950, DSI).

In response to the feedback received at step 960, the TRP 901, at step 965, may schedule a fourth transmission to the UE 902 and perform the fourth transmission. Assuming that the feedback includes information indicating that the degree of distortion present in the second subset of the source data transmitted at step 950 was relatively low, the TRP 901 may transmit a third subset of the source data that is different from the first and second subsets of the source data, in order to reduce the total compression ratio (but in exchange avoid a HARQ retransmission of the second subset of source data). The TRP 901 may determine to transmit the third subset in the fourth transmission, based on the feedback and/or an internal algorithm of the TRP 901, e.g., that compares the degree of distortion to a threshold and determines to transmit the third subset of the source data when the distortion is below the threshold. The TRP 901 may transmit the third subset with an initial redundancy version, e.g., RV0. The TRP 901 may also transmit information identifying the same source process identifier (e.g., source process identifier=M) as the previous transmissions. The manner in which the TRP 901 transmits the third subset of the source data may be similar to the manner in which the first and second subsets of the source data are previously transmitted. For example, the third subset of the source data may be transmitted with at least one of an identifier for the third subset of the source data (e.g., index of the third subset of the source data), information indicative of a location of the third subset of the source data within the source data, information identifying a source process identifier indicative of the source data (e.g., source process identifier=M), a new data indicator (NDI) indicative of whether a buffer associated with the source process identifier is to be flushed, or information indicative of redundancy version for the third subset of the source data.

At step 970, after receiving the third subset of the source data from the TRP 901, the UE 902 may perform a channel decoding (and possibly a source decoding) for the third subset of the source data. For the purpose of illustration, it is assumed that the channel decoding of the third subset of the source data was correctly performed (e.g., channel decoding ACK). Then, the UE 902 may combine the first, second, and third subsets of the source data, and perform the source recovery or the task execution using the combined first, second, and third subsets of the source data. The compression ratio may be lowered due to the fact that all of the first, second, and third subsets of the source data are transmitted. Here, the first and third subsets of the source data are correctly channel decoded ones, and the second subset of the source data is a distorted one. For the purpose of illustration, it is also assumed that the source recovery or task execution was also successfully performed at step 970. For example, even though the second subset of source data is distorted (channel decoding failed), the UE 902 had correctly channel decoded the first and third subsets of source data, and this combined with the distorted information from the second subset of source data was enough to generate a satisfactory source recovery or task execution. In one example, task execution by the UE involves generating an inference using, as input to the UE-side neural network, the features represented by the first subset of source data (correctly channel decoded), the features represented by the second subset of source data (distorted because channel decoding failed), and the features represented by the third subset of source data (correctly channel decoded). The inference generated has an accuracy above a certain threshold (e.g., the inference is associated with a 90% probability of being correct), and so task execution is considered to be successfully performed.

At step 975, the UE 902 may transmit feedback to the TRP 901, in the same manner as steps 930, 945 and 960. The feedback may include the outcome of the channel decoding performed at step 970 (e.g., channel decoding ACK) and/or the performance information indicating that the performance of the source recovery or the task execution was successful at step 970 (e.g., Source ACK, source recovery or task execution status information). In some embodiments, the feedback may not include the outcome of the channel decoding performed at step 970 (e.g., channel decoding ACK), to reduce the air interface overhead. This is possible because the fact that source recovery or the task execution was successful, which means that further transmission is not needed, so it does not matter whether or not channel decoding was successful. The feedback may further include, in some embodiments, other information in the similar manner as steps 930, 945, and 960, although such feedback may be omitted if source recovery or task execution was successful.

After receiving the feedback at step 975, the TRP 901 may schedule transmission of another source data to the UE 902. At step 980, the TRP 901 may transmit information comprising a source process identifier indicative of the source data (e.g., source process ID=M) and an indication triggering flush of a buffer associated with the source process identifier (e.g., a toggled new data indicator (NDI)). The manner of the transmission at step 980 may be similar to that described above for other transmissions.

At step 985, the UE 902 may receive the information transmitted at step 980, which may include the source process identifier (e.g., source process ID=M) and the indication triggering flush of the buffer associated with the source process identifier (e.g., toggled NDI). Based on the indication triggering (e.g., toggled NDI), the UE 902 may flush the buffer associated with the source process identifier.

According to some embodiments, as mentioned above in connection with the optional step 905, the TRP 901 or the UE 902 may map each portion of the source data to each subset of the source data based on importance of respective portion of the source data. For example, a first portion of the source data is mapped to the first subset of the source data based on importance of the first portion of the source data, and a second portion of the source data is mapped to the second subset of the source data based on importance of the second portion of the source data. In other words, each subset of the source data transmitted from the TRP 901 to the UE 902 may be ordered in term of their importance.

When each subset of the source data is ordered based on their importance, the subsets of the source data may be transmitted for example in a manner described in FIG. 11A. The first subset of the source data transmitted in the first and second transmissions in FIG. 9 (i.e., steps 920 and 935) may correspond to the most important feature (i.e., 1^{st} important feature) to the M^{th} important feature. In this example, it is assumed that the second transmission is a retransmission of the first subset of the source data. The second subset of the source data transmitted in the third transmissions in FIG. 9 (i.e., step 950) may correspond to the (M+1)^{th} important feature to the (M+K)^{th} important feature. The third subset of the source data transmitted in the fourth transmissions in FIG. 9 (i.e., step 965) may correspond to the (M+K+1)^{th} important feature to the (M+K+N)^{th} important feature.

In other words, when each subset of the source data is ordered based on their importance, in the case of the data transmission described above and FIG. 9, the most important feature (i.e., 1^{st} important feature) to the M^{th} important feature are transmitted from the TRP 901 to the UE 902 in the first and second transmissions, the (M+1)^{th} important feature to the (M+K)^{th} important feature are transmitted from the TRP 901 to the UE 902 in the third transmission, and the (M+K+1)^{th} important feature to the (M+K+N)^{th} important feature are transmitted from the TRP 901 to the UE 902 in the fourth transmission, as illustrated in FIG. 11A. The UE 902 may combine the received features to perform source recovery or task execution (e.g., AI/ML inference) in the manner described above and in FIG. 9.

In some embodiments, as mentioned above in connection with the optional step 905, the TRP 901 or the UE 902 may map each portion of the source data to each subset of the source data regardless of importance of each portion of the source data. One example is illustrated in FIG. 11B. In FIG. 11B, a first portion of the source data is mapped to the first subset of the source data based on indices of the first portion of the source data, and a second portion of the source data is mapped to the second subset of the source data based on indices of the second portion of the source data.

When each subset of the source data is ordered based on their indices, the subsets of the source data may be transmitted for example in a manner described in FIG. 11B, in order of increasing indices of the features, i.e., the feature with the lowest index is transmitted first, and the feature with the highest index is transmitted last. The first subset of the source data transmitted in the first and second transmissions in FIG. 9 (i.e., steps 920 and 935) may correspond to the features having index 1 to index M. In this example, it is assumed that the second transmission is a retransmission of the first subset of the source data. The second subset of the source data transmitted in the third transmissions in FIG. 9 (i.e., step 950) may correspond to the features having index (M+1) to index (M+K). The third subset of the source data transmitted in the fourth transmissions in FIG. 9 (i.e., step 965) may correspond to the features having index (M+K+1) to index (M+K+N).

While not described in FIGS. 11A and 11B, in some embodiments, each subset of the source data transmitted from the transmitting device (e.g., TRP 901) to the receiving device (e.g., UE 902) may be ordered randomly or based on some other predetermined rules.

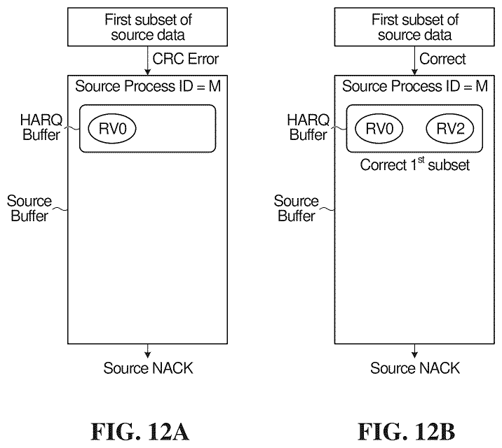

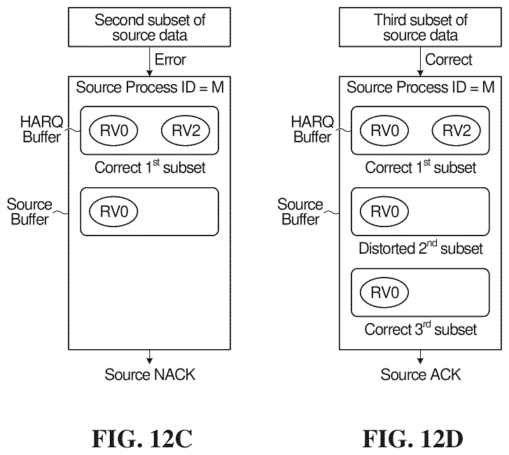

FIG. 12A to 12D illustrate an example operation of a UE in various stages of the data transmission described above and in FIG. 9, in accordance with some embodiments of the present disclosure.

FIG. 12A is the first transmission of source data and may correspond to step 925 of FIG. 9. A TRP may transmit a first subset of source data to the UE in the first transmission. The TRP may also transmit the redundancy version (e.g., RV0) and the source process identifier (e.g., Source Process ID=M) for the first subset of the source data in the first transmission. After receiving the first subset of the source data, the UE may perform channel decoding. For the purpose of illustration, it is assumed that the channel decoding of the first subset transmitted in the first transmission failed (e.g., channel decoding NACK, CRC error). The redundancy version (e.g., RV0) may be stored at the HARQ buffer for the first subset of the source data. The UE may perform source recovery or task execution using the first subset of source data received in the first transmission. For the purpose of illustration, it is assumed that the source recovery or task execution failed this time. The UE may report, to the TRP, the performance information indicating that the source recovery or task execution failed (e.g., Source NACK) and the channel decoding outcome indicating that the channel decoding of the first subset of source data failed (e.g., HARQ NACK).

FIG. 12B is the second transmission of the source data and may correspond to step 940 of FIG. 9. As the degree of distortion is relatively high, the TRP may retransmit the first subset of source data to the UE in the second transmission. The TRP may also transmit the redundancy version (e.g., RV2) and the source process identifier (e.g., Source Process ID=M) for the first subset of the source data in the second transmission. After receiving the retransmitted first subset of the source data, the UE may perform channel decoding. As the first subset of source data was retransmitted in the second transmission, the UE may perform HARQ with combining the first subset of the source data transmitted in the first transmission and the first subset of the source data retransmitted in the second transmission (e.g., combining RV0 and RV2). For the purpose of illustration, it is assumed that the channel decoding of the first subset retransmitted in the second transmission succeeded (e.g., channel decoding ACK, Correct). The redundancy version (e.g., RV2) may be stored at the HARQ buffer for the first subset of the source data. The UE may perform source recovery or task execution using the first subset of source data received in the first and second transmissions. For the purpose of illustration, it is assumed that the source recovery or task execution failed again in FIG. 12B. The UE may report, to the TRP, the performance information indicating that the source recovery failed (e.g., Source NACK) and the channel decoding outcome indicating that the channel decoding of the first subset of source data was successful (e.g., channel decoding ACK, Correct).

In some embodiments, when the channel decoding for the first subset was successful, for example as described above and in FIG. 12B, the channel decoded first subset of the source data may be stored in the source buffer. The first subset of the source data stored in the source buffer may be used for source recovery or task execution.

FIG. 12C is the third transmission of the source data and may correspond to step 955 of FIG. 9. As the channel decoding for the first subset was successful (and in some embodiments, the channel decoded first subset of the source data may be buffered in the source buffer), the TRP may transmit a second subset of source data (different from the first subset in the first and second transmission) to the UE in the third transmission. The TRP may also transmit the redundancy version (e.g., RV0) and the source process identifier (e.g., Source Process ID=M) for the second subset of the source data in the third transmission. After receiving the second subset of the source data, the UE may perform channel decoding. For the purpose of illustration, it is assumed that the channel decoding of the second subset transmitted in the third transmission failed (e.g., channel decoding NACK, Error). The redundancy version (e.g., RV0) may be stored at the HARQ buffer for the second subset of the source data. As a different subset of source data was received in the third transmission, the UE may combine the first and second subsets of the source data to perform the source recovery or the task execution. In some embodiments, as mentioned above, the first subset of the source data may be stored in the source buffer. The first subset of the source data is correct, but the second subset of the source data is distorted, based on the channel decoding outcome. The UE may perform source recovery or task execution using the correct first subset of the source data and the distorted second subset of source data. For the purpose of illustration, it is assumed that the source recovery failed again in FIG. 12C. The UE may report, to the TRP, the performance information indicating that the source recovery failed (e.g., Source NACK) and the channel decoding outcome indicating that the channel decoding of the first subset of source data failed (e.g., channel decoding NACK, Error).

FIG. 12D is the fourth transmission of the source data and may correspond to step 970 of FIG. 9. As the degree of distortion for the second subset of the source data was relatively low, the TRP may transmit a third subset of source data (different from the first and second subsets of the source data) to the UE in the fourth transmission. The TRP may also transmit the redundancy version (e.g., RV0) and the source process identifier (e.g., Source Process ID=M) for the third subset of the source data in the fourth transmission. After receiving the third subset of the source data, the UE may perform channel decoding. For the purpose of illustration, it is assumed that the channel decoding of the third subset transmitted in the fourth transmission succeeded (e.g., channel decoding ACK, Correct). The redundancy version (e.g., RV0) may be stored at the HARQ buffer for the third subset of the source data. As a different subset of source data was received in the fourth transmission, the UE may combine the first, second and the third subsets of the source data to perform the source recovery or the task execution. The first and third subsets are correct, but the second subset is distorted, based on the channel decoding outcome. In some embodiments, as mentioned above, the first subset of the source data may be stored in the source buffer. The UE may perform source recovery or task execution using the correct first and third subsets of source data and the distorted second subset of the source data. For the purpose of illustration, it is assumed that the source recovery was successfully performed this time. The UE may report, to the TRP, the performance information indicating that the source recovery or task execution was successful (e.g., Source ACK) and optionally the channel decoding outcome indicating that the channel decoding of the first subset of source data was also successful (e.g., channel decoding ACK, Correct). As the source recovery or task execution was successful, the UE may not separately report the channel decoding outcome to reduce the air interface overhead.

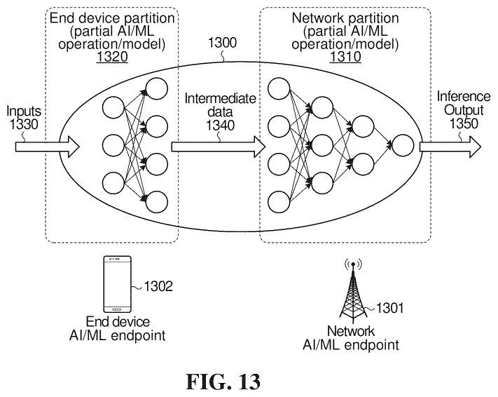

FIG. 13 illustrates an example of split AI/ML operation between two AI/ML endpoints for an uplink (UL) inference, in accordance with some embodiments of the present disclosure. Referring to FIG. 13, the AI/ML model 1300 may be split into two partitions. The network side partition of the AI/ML model 1300 may be the partial AI/ML model 1310, and the end device side partition of the AI/ML model 1300 may be the partial AI/ML model 1320.

The training of the AI/ML model 1300 may be split into two parts. The training of the partial AI/ML model 1310, which may include computation-intensive and/or energy-intensive parts of the AI/ML model training, is performed at the network AI/ML endpoint 1301 (e.g., TRP). The training of the partial AI/ML model 1320, which may include privacy-sensitive and delay-sensitive parts of the AI/ML model training, may be performed at the end device AI/ML endpoint 1302 (e.g., UE). As the split AI/ML inference described in FIG. 13 is a UL inference, the end device AI/ML endpoint 1302 may take the inputs 1330 and perform specific part or layers of the AI/ML model training, which corresponds to the training of the partial AI/ML model 1320, using the inputs 1330. After the training of the partial AI/ML model training 1320 is complete, the end device AI/ML endpoint 1302 may transmit, to the network AI/ML endpoint 1301, the intermediate data 1340 or the output of the training of the partial AI/ML model 1320. The network AI/ML endpoint 1301 may receive the intermediate data 1340 and perform the other part or layers of the AI/ML model training, which corresponds to the training of the partial AI/ML model 1310, using intermediate data 1340 as input. The network AI/ML endpoint 1301 may obtain the inference output 1350 after the training of the partial AI/ML model 1310, and possibly transmit the inference output 1350 back to the end device AI/ML endpoint 1302.

In connection with the data transmission method described in the present disclosure, the intermediate data 1340 may be the source data that is exchanged between two devices (e.g., TRP, UE) across the network. This intermediate data 1340 may be generated during training or during use post-training.

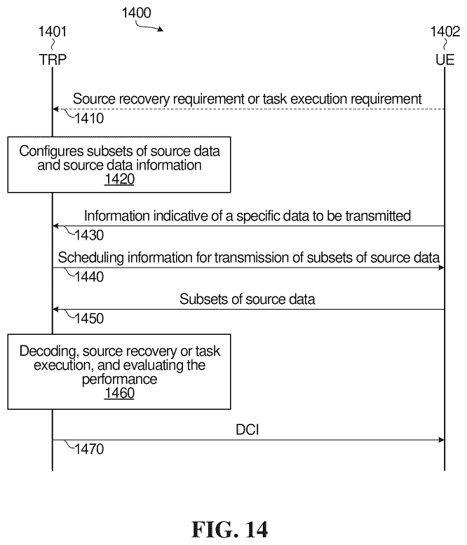

FIG. 14 illustrates an example process 1400 for transmitting data from a UE to a TRP, in accordance with some embodiments of the present disclosure. The TRP 1401 may be a receiving device (e.g., receiving device 372 illustrated in FIG. 5) and implement encoding operations (e.g., JSCC). The UE 1402 may be a transmitting device (e.g., transmitting device 352 illustrated in FIG. 5) and implement decoding operations and feedback. In some embodiments, the TRP 1401 may be a network AI/ML endpoint and perform UL AI/ML inference using the intermediate data received from the UE 1402, and the UE 1402 may be an end device AI/ML endpoint and transmit intermediate data (e.g., intermediate data 1340 in FIG. 13) or output of training of a partial AI/ML model trained at the UE 1402. In the example process 1400, the source data transmitted from the UE 1402 to the TRP 1401 may be intermediate data, which is an output of the partial AI/ML model trained at the UE 1402. The intermediate data transmitted from the UE 1402 to the TRP 1401 may be 128 feature maps illustrated above.

Contrary to the process 900 described above and in FIG. 9, process 1400 describes UL data transmission (i.e., the direction of data transmission is opposite). As such, contrary to the TRP 901 and the UE 902 in the process 900, the TRP 1401 is a receiving device and the UE 1402 is a transmitting device in the process 1400. However, there exist similarities between the process 900 and the process 1400. Generally speaking, operations of the TRP 1401 may be similar to those of the UE 902, and operations of the UE 1402 may be similar to those of the TRP 901. Therefore, the process 1400 will be described below and in FIG. 14, focusing on the aspects that are different from the process 900. Aspects of the process 1400 that are similar to those of the process 900 may not be repeatedly illustrated for simplicity.

At step 1410, which is an optional step, the UE 1402 may report requirements for the source recovery or the task execution. The requirement for the source recovery may be the source resolution threshold, and/or source accuracy threshold. The requirement for the task execution may be the inference accuracy threshold (AI/ML inference accuracy threshold), and/or uncertainty threshold. As shown in FIG. 14, the UE 1402 may transmit the source recovery or task execution requirements to the TRP 1401 before transmission of the source data. The source recovery or task execution requirements reported by the UE 1402 may assist the TRP 1401 to determine whether source recovery or task implementation is successful. For example, the TRP 1401 may evaluate the performance of the source recovery or the task execution based on the source recovery or task execution requirements reported by the UE 1402.

In some embodiments, the source recovery or task execution requirements may be predetermined. In such embodiments, the UE 1402 may not need to transmit the source recovery or task execution requirements to the TRP 1401. In some embodiments, the TRP 1401/network may determine the source recovery or task execution requirements.

At step 1420, the TRP 1401 may configure a plurality of subsets of the source data to be transmitted by the UE 1402. The TRP 1401, at step 1420, may also configure source data information, which may include at least one of a compression ratio for the source data, location information indicating a location of each subset of the source data within the source data, a compression version associated with the compression ratio, and/or a compression version indicative of the location information. The acts or operations of the TRP 1401 at step 1420 may be similar to those of the TRP 901 at step 910 in FIG. 9.

At step 1430, the UE 1402 may transmit, to the TRP 1401, information indicative of a specific data to be transmitted by the UE 1402. The information indicative of the specific data may indicate that, for example, the UE 1402 is to transmit a new source data or multiple source data.

Step 1430 may be performed to indicate that the UE 1402 will transmit a specific data, which may be one type of local traffic such as sensing data and AI/ML model training data (e.g., intermediate data 1340 in FIG. 13), so that the TRP 1401 and UE 1402 may perform the method of FIG. 14 (involving transmission of only subsets of source data). Otherwise, if the data is received from the core network which is transparent to the TRP 1401, the TRP 1401 may use the conventional HARQ mechanism, which may only consider modulation order and channel coding rate adaptation, for data transmission.

In some embodiments, the information indicative of the specific data may include at least one of a scheduling request (SR) or a buffer status report (BSR). The specific SR resource may be configured to be used for a certain type of data (e.g., sensing data in local traffic). This way, when a specific SR resource is detected by the TRP 1401, the TRP 1401 may know the type of the data transmitted using that specific SR resource. The BSR may include information about the data to be transmitted by the UE 1402. The BSR may include the total amount of packets (e.g., the total number of source data) that will be transmitted by the UE 1402. The BSR may (also) include whether the size and/or the data format of a packet (e.g., source data) is predetermined or configured by the TRP 1401 (e.g., a packet includes 128 feature maps). The TRP 1401 may know the total number of the packets based on the received BSR, and perform scheduling for each transmission of each packet, e.g., by the incremental transmission until the packet is successfully recovered.

At step 1440, the TRP 1401 may transmit, to the UE 1402, scheduling information for transmission of a (first) subset of the source data. The TRP 1401 may transmit the scheduling information with at least one of an identifier for the (first) subset of the source data (e.g., index of the (first) subset of the source data), information indicative of a location of the (first) subset of the source data within the source data, information identifying a source process identifier indicative of the source data (e.g., source process identifier=M), a new data indicator (NDI) indicative of whether a buffer associated with the source process identifier is to be flushed, or information indicative of redundancy version for the (first) subset of the source data. The NDI may be indicative of whether the source data is different from source data transmitted, in a preceding transmission (e.g., an immediately preceding transmission), with an identifier that is equal to the source process identifier of the source data. The acts or operations of the TRP 1401 at step 1440 may be similar to those of the TRP 901 at step 920 in FIG. 9, except that the TRP 1401 does not actually transmit a (first) subset of the source data in step 1440.

At step 1450, the UE 1402 may transmit the (first) subset of the source data according to the scheduling information received from the TRP 1401. The manner in which the UE 1402 transmits the subset of the source data may be similar to the manner in which the TRP 901 transmits the subset of the source data in FIG. 9.

At step 1460, the TRP 1401 may perform a channel decoding (and possibly a source decoding) for the received (first) subset of the source data and perform source recovery or task execution using the channel and/or source decoded (first) subset of the source data.

Steps 1440 to 1460 may be repeated until the source recovery or the task execution is performed successfully at the TRP 1401. In each transmission, whether the UE 1402 transmits the same or different subset of the source data (compared to the subset transmitted in the previous transmission) may be determined in the similar manner described above and elsewhere in the present disclosure (e.g., FIG. 9).

When the source recovery or the task execution is performed successfully at the TRP 1401, the TRP 1401, at step 1470, may transmit, to the UE 1402, a downlink control information (DCI). The DCI may include a source process identifier indicative of the source data (e.g., source process ID=M) and an indication triggering flush of a buffer associated with the source process identifier (e.g., a toggled new data indicator (NDI)). Based on the indication triggering (e.g., toggled NDI), the UE 1402 may flush the buffer associated with the source process identifier. The manner in which the UE 1402 flushes the buffer may be similar to that in which the UE 902 flushes at step 985 of FIG. 9.

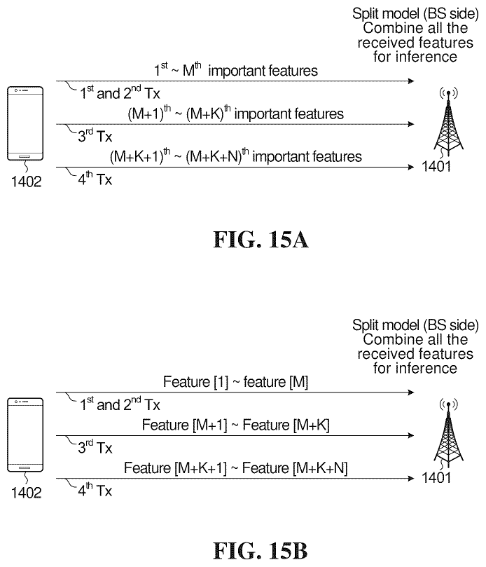

In some embodiments where each subset of the source data is ordered based on their importance, the uplink transmission of the source data may be performed for example in a manner described in FIG. 15A. The first subset of the source data may correspond to the most important feature (i.e., 1^{st} important feature) to the M^{th} important feature and may be transmitted from the UE 1402 to the TRP 1401 in the first and second transmissions, as shown in FIG. 15A (assuming in this example that the second transmission is a retransmission of the first subset of source data). The second subset of the source data may correspond to the (M+1)^{th} important feature to the (M+K)^{th} important feature and may be transmitted from the UE 1402 to the TRP 1401 in the third transmissions, as shown in FIG. 15A. The third subset of the source data may correspond to the (M+K+1)^{th} important feature to the (M+K+N)^{th} important feature and may be transmitted from the UE 1402 to the TRP 1401 in the fourth transmissions, as shown in FIG. 15A. The four transmissions described in FIG. 15A may correspond to step 1450 of FIG. 14.

In some embodiments where each subset of the source data is ordered based on their indices, the uplink transmission of the source data may be performed for example in a manner described in FIG. 15B, in order of increasing indices of the features, i.e., the feature with the lowest index is transmitted first, and the feature with the highest index is transmitted last. The first subset of the source data may correspond to the features having index 1 to index M and may be transmitted from the UE 1402 to the TRP 1401 in the first and second transmissions, as shown in FIG. 15B (assuming in this example that the second transmission is a retransmission of the first subset of source data). The second subset of the source data may correspond to the features having index (M+1) to index (M+K) and may be transmitted from the UE 1402 to the TRP 1401 in the third transmissions, as shown in FIG. 15B. The third subset of the source data may correspond to the features having index (M+K+1) to index (M+K+N) and may be transmitted from the UE 1402 to the TRP 1401 in the fourth transmissions, as shown in FIG. 15B. The four transmissions described in FIG. 15B may correspond to step 1450 of FIG. 14.

While not described in FIGS. 15A and 15B, in some embodiments, each subset of the source data transmitted from the transmitting device (e.g., UE 1402) to the receiving device (e.g., TRP 1401) may be ordered randomly or based on some other predetermined rules.

The embodiments described above are in the context of UEs communicating with a TRP. However, more generally, devices that wirelessly communicate with each other over time-frequency resources need not necessarily be one or more UEs communicating with a TRP. For example, two or more UEs may wirelessly communicate with each other over a sidelink using device-to-device (D2D) communication. As another example, two network devices (e.g. a terrestrial base station and a non-terrestrial base station, such as a drone) may wirelessly communicate with each other over a backhaul link. Embodiments are not limited to uplink and/or downlink communication. For example, in the embodiments above, the TRP 901 or 1401 may be substituted with another device, such as a node in the network or a UE. The uplink/downlink communication may instead be sidelink communication.

### Conclusion

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method comprising:
transmitting, in a first transmission, first data that is channel encoded;
receiving feedback indicating that a further transmission related to the first data is required; and
in response to the receiving the feedback, transmitting a second transmission comprising either a retransmission of the first data or a transmission of second data that is different from the first data.

2. The method of claim 1, wherein the first data is a first subset of source data and the second data is a second subset of the source data that is different from the first subset of the source data.

3. The method of claim 2, wherein the feedback indicates at least one of:
a channel decoding outcome of the first subset of the source data transmitted in the first transmission;
a source decoding outcome associated with the first subset of the source data transmitted in the first transmission;
a degree of distortion present in the first subset of the source data transmitted in the first transmission after channel decoding of the first subset of the source data; or
performance of source recovery or task execution that was based on the first subset of the source data transmitted in the first transmission.

4. The method of claim 3, further comprising:
configuring a performance criterion to be used for evaluating the performance of the source recovery or the task execution; and
transmitting the performance criterion.

5. The method of claim 3, further comprising:
receiving second feedback indicating at least one of:
a second channel decoding outcome of the first subset or the second subset of the source data transmitted in the second transmission;
a second source decoding outcome associated with the first subset or the second subset of the source data transmitted in the second transmission;
how much distortion is present in the first subset or the second subset of the source data transmitted in the second transmission; or
performance of the source recovery or the task execution that was based on the first subset or the second subset of the source data transmitted in the second transmission.

6. The method of claim 2, wherein the first subset of the source data is transmitted or retransmitted with at least one of:
an identifier for the first subset of the source data;
information indicating a location of the first subset of the source data within the source data;
information identifying a source process identifier indicative of the source data;
a new data indicator indicating whether a buffer associated with the source process identifier is to be flushed; or
information indicating redundancy version for the first subset of the source data.

7. The method of claim 2, further comprising:
mapping a first portion of the source data to the first subset of the source data based on first importance of the first portion of the source data;
mapping a second portion of the source data to the second subset of the source data based on second importance of the second portion of the source data;
configuring an importance criterion to be used for determining the importance of the first portion of the source data and the importance of the second portion of the source data;
transmitting the importance criterion; and
receiving information indicating whether the first importance of the first portion of the source data is greater than the second importance of the second portion of the source data.

8. A device comprising:
at least one processor coupled to a memory, the memory storing processor-executable instructions that, when executed by the at least one processor, cause the device to perform:
transmitting, in a first transmission, first data that is channel encoded;
receiving feedback indicating that a further transmission related to the first data is required; and
in response to the receiving the feedback, transmitting a second transmission that comprising either a retransmission of the first data or a transmission of second data that is different from the first data.

9. The device of claim 8, wherein the first data is a first subset of source data, and the second data is a second subset of the source data that is different from the first subset of the source data.

10. The device of claim 9, wherein the feedback indicates at least one of:
a channel decoding outcome of the first subset of the source data transmitted in the first transmission;
a source decoding outcome associated with the first subset of the source data transmitted in the first transmission;
a degree of distortion present in the first subset of the source data transmitted in the first transmission after channel decoding of the first subset of the source data; or
performance of source recovery or task execution that was based on the first subset of the source data transmitted in the first transmission.

11. The device of claim 10, wherein the processor-executable instructions, when executed, further cause the device to perform:
configuring a performance criterion to be used for evaluating the performance of the source recovery or the task execution; and
transmitting the performance criterion.

12. The device of claim 10, wherein the processor-executable instructions, when executed, further cause the device to perform:
receiving second feedback indicating at least one of:
a second channel decoding outcome of the first subset or the second subset of the source data transmitted in the second transmission;
a second source decoding outcome associated with the first subset or the second subset of the source data transmitted in the second transmission;
how much distortion is present in the first subset or the second subset of the source data transmitted in the second transmission; or
performance of the source recovery or the task execution that was based on the first subset or the second subset of the source data transmitted in the second transmission.

13. The device of claim 9, wherein the first subset of the source data is transmitted or retransmitted with at least one of:
an identifier for the first subset of the source data;
information indicating a location of the first subset of the source data within the source data;
information identifying a source process identifier indicative of the source data;
a new data indicator indicating whether a buffer associated with the source process identifier is to be flushed; or
information indicating redundancy version for the first subset of the source data.

14. The device of claim 9, wherein the processor-executable instructions, when executed, further cause the device to perform:
mapping a first portion of the source data to the first subset of the source data based on first importance of the first portion of the source data;
mapping a second portion of the source data to the second subset of the source data based on second importance of the second portion of the source data;
configuring an importance criterion to be used for determining the first importance of the first portion of the source data and the second importance of the second portion of the source data;
transmitting the importance criterion; and
receiving information indicating whether the first importance of the first portion of the source data is greater than the second importance of the second portion of the source data.

15. An apparatus comprising:
at least one processor coupled to a memory, the memory storing processor-executable instructions that, when executed by the at least one processor, cause the apparatus to perform:
receiving, in a first transmission, first data that is channel encoded;
transmitting feedback indicating that a further transmission related to the first data is required; and
receive, in a second transmission, either a retransmission of the first data or second data that is different from the first data.

16. The apparatus of claim 15, wherein the first data is a first subset of source data and the second data is a second subset of the source data that is different from the first subset of the source data.

17. The apparatus of claim 16, wherein the feedback indicates at least one of:
a channel decoding outcome of the first subset of the source data received in the first transmission;
a source decoding outcome associated with the first subset of the source data received in the first transmission;
a degree of distortion present in the first subset of the source data received in the first transmission after channel decoding of the first subset of the source data; or
performance of source recovery or task execution, wherein the source recovery or the task execution is performed using the first subset of the source data received in the first transmission,
wherein the second transmission comprises either the retransmission of the first subset of the source data or the second subset of the source data, based on the degree of distortion present in the first subset of the source data received in the first transmission after the channel decoding of the first subset of the source data.

18. The apparatus of claim 17, wherein the first subset of the source data is received in the second transmission, and wherein the processor-executable instructions, when executed, further cause the apparatus to perform:
performing hybrid automatic repeat request (HARQ) with combining the first subset of the source data received in the first transmission and the first subset of the source data received in the second transmission to obtain channel decoded first subset of the source data; and
performing the source recovery or the task execution using the channel decoded first subset of the source data.

19. The apparatus of claim 17, wherein the second subset of the source data is received in the second transmission, and wherein the processor-executable instructions, when executed, further cause the apparatus to perform:
combining the first subset of the source data received in the first transmission and the second subset of the source data received in the second transmission; and
performing the source recovery or the task execution using the combined first subset and second subset of the source data.

20. The apparatus of claim 17, wherein the processor-executable instructions, when executed, further cause the apparatus to perform:
transmitting second feedback indicating at least one of:
a second channel decoding outcome of the first subset or the second subset of the source data received in the second transmission;
a second source decoding outcome associated with the first subset or the second subset of the source data received in the second transmission;
how much distortion is present in the first subset or the second subset of the source data received in the second transmission; or
performance of the source recovery or the task execution, wherein the source recovery or the task execution is performed using the first subset or the second subset of the source data received in the second transmission.
